(19) United States
(12) Patent Application Publication
(10) Pub. No.: US 2014/0302216 A1
(43) Pub. Date: Oct. 9, 2014

(54) ENDOLYSINS FOR CONTROLLING LISTERIA IN PASTA FILATA CHEESE AND RELATED FOOD PRODUCTS

(71) Applicants: Jacobus Stark, Echt (NL); Maartje Maria Franse, Echt (NL); William Robert King, Walnut Creek, CA (US)

(72) Inventors: Jacobus Stark, Echt (NL); Maartje Maria Franse, Echt (NL); William Robert King, Walnut Creek, CA (US)

(73) Assignee: DSM IP ASSETS B.V., Heerlen (NL)

(21) Appl. No.: 14/119,790

(22) PCT Filed: May 29, 2012
(86) PCT No.: PCT/EP2012/002267

§ 371 Date: Mar. 11, 2014

Related U.S. Application Data
(60) Provisional application No. 61/490,245, filed on May 26, 2011.

(30) Foreign Application Priority Data
Jul. 13, 2011 (EP) 11005721.3
Jul. 28, 2011 (EP) 11175777.9

(51) Int. Cl. A23C 19/11; A23C 19/068

(52) U.S. Cl. CPC A23C 19/11; A23C 19/0684
USPC 426/532; 424/94.6

(57) ABSTRACT

The present invention relates to the use of Listeria bacteriophage endolysins for controlling Listeria contamination of pasta filata cheese and related food products. The present invention also relates to the use of Listeria bacteriophage endolysins for extending the shelf life of pasta filata cheese and related food products. Furthermore, the present invention relates to a food product comprising pasta filata cheese and a Listeria bacteriophage endolysin as well as a method of making such a food product.

### FIELD OF THE INVENTION

The present invention relates to the use of Listeria bacteriophage endolysins for controlling Listeria contamination of pasta filata cheese and related food products. In particular, the present invention relates to the use of Listeria bacteriophage endolysins having a pH optimum of 6.0 or below with respect to their lytic activity for controlling Listeria contamination of pasta filata cheese and related food products. More specifically, the present invention relates to the use of Listeria bacteriophage endolysins having a pH optimum of 6.0 or below with respect to their lytic activity for controlling Listeria contamination of mozzarella cheese and related food products.

### BACKGROUND OF THE INVENTION

Mozzarella is a semi-soft fresh cheese produced from cow or buffalo milk. To produce mozzarella, fresh milk is first standardized by addition of milk solids, pasteurized, and then cooled to a processing temperature of between 35° C. and 45° C. Thermophilic starter cultures consisting of Streptococcus thermophilus, Lactobacillus bulgaricus, or other closely related strains are added to the warm, pasteurized milk and the milk is then incubated for between 30 and 90 minutes until acid production, as measured by pH, begins. As soon as the pH drops to around 6.3 or lower, a coagulant such as rennet is added to curdle the milk. Within 15 minutes, the milk transforms into a soft semi-solid gel. This gel, or curd, can then be cut with knives into large soft ribbons. These large slices of curd begin to shrink and firm up due to continuing acid production by the starter. As the curd begins to contract and firm up it is further cut into smaller pieces. These curds are stirred and heated to permit removal of non-cheese moisture, also known as sweet whey. The whey is gradually drained from the curds, which may then be pumped into molds or onto draining belts, where they continue to lose whey and increase in firmness until the pH reaches around 5.5 to 5.2. This is the point at which the curd can be further melted and stretched, by contact with very hot water. As the cheese reaches a temperature of more than 45° C., it can then be stretched and kneaded to produce a delicate but stringy consistency—this process is generally known as pasta filata. The curd can then be formed into ball shapes, strings, loaves or other forms, after which it is immersed in a bath of cold brine water. The chilling step reduced the curd temperature to around 4° C. or less, after which it may be packaged, stored, and shipped for consumption. Mozzarella can also be stored at −20° C. and then thawed at 4° C.; it then still has a shelf life of 14 to 30 days. The shelf life of mozzarella cheese in conventional air package is 14-16 days. However, increase in shelf life can be achieved: 90 days under 100% CO₂, 75 days under 50% CO₂ and 50% N₂, and 65 days under 100% N₂ during deep-freeze conditions.

Conventionally, mozzarella cheese and other pasta filata cheeses are made with thermophilic lactic streptococci and lactobacilli as described above. However, mozzarella cheese and other pasta filata cheeses can also be made by using organic acids and acidulants such as lactic acid, acetic acid, citric acid and glucono-deltalactone, without the use of cultures.

Contamination by Listeria has become a problem over the past 30 years in many parts of the world. The ubiquitous nature of Listeria monocytogenes, its capacity to multiply at refrigeration temperatures (4° C. or 39° F.), its thermal tolerance, and its resistance to relatively low pH, together with its tolerance of high salt concentrations, make controlling this pathogenic microorganism in food products difficult (Dieuleveux et al. 1998, Appl. Environ. Microbiol. 64(2):800-803). L. monocytogenes has been found in uncooked meats, uncooked vegetables, unpasteurized milk, foods made from unpasteurized milk, and processed foods. This bacterium has been incriminated in several cases of food poisoning. In humans, L. monocytogenes can cause listeriosis. At particular risk are the immuno-depressed, the old, pregnant women, fetuses, and newborn babies. Several groups have worked on biological control of Listeria.

Listeria can grow at refrigeration temperatures and survive freezing as well. Furthermore, they have been shown to be able to grow and survive under elevated CO₂ concentrations at low temperatures.

Pasta filata, non-cured, low salt and other high risk cheese products may be subject to contamination by bacterial pathogens during the cheese making process, especially after the melting step. Pathogens such as Listeria monocytogenes may be found in the cheese making plant environment, due to their ability to grow and form stable bio-films in drains, on floors, and on food contact surfaces. Very low levels of Listeria may come into contact with the finished cheese, and then survive during packaging, storing, and shipping. Listeria bacteria are of greater concern than other bacteria due to their ability to grow on foods at refrigeration temperatures. Storage of cheese for prolonged periods may then allow Listeria counts to reach potentially infective levels. Consumption of cheese containing high counts of Listeria monocytogenes can result in gastroenteritis or even severe invasive life threatening infections, especially in pregnant women and in immune compromised individuals. Existing food grade anti-microbials such as nisin have not been effective for controlling Listeria on high risk cheeses, due to interference of the anti-microbial activity by the cheese composition, which appears to reduce or neutralize the activity of most anti-microbials. At this point in time, there is a strong need for technology capable of either killing or controlling the growth of Listeria on pasta filata or other high risk cheeses after manufacturing. A solution to this problem would have significant benefits for the cheese industry, potentially reducing the risk of Listeria being present in products that are consumed by at-risk individuals. The present invention provides a solution to the problem of controlling Listeria in pasta filata cheeses.

### SUMMARY OF THE INVENTION

Bacteriophages are viruses that infect bacteria. They are obligate intracellular parasites and lack their own metabolism. Phages are the natural enemies of bacteria. They are host-specific in that they infect specific bacterial species or even specific strains (Hagens and Loessner 2007, Appl. Microbiol. Biotechnol. 76(3):513-519). The extreme specificity of phages renders them ideal candidates for applications designed to increase food safety.

Endolysins are double-stranded DNA bacteriophage-encoded highly active enzymes, which hydrolyse bacterial cell walls. These phage-encoded cell wall lytic enzymes are synthesized late during virus replication and mediate the release of progeny virions. They induce lysis of the bacterial cell and thereby enable progeny virions to be released. Endolysins are also capable of degrading peptidoglycan when applied externally (as purified recombinant proteins) to the bacterial cell wall, which also results in a rapid lysis of the bacterial cell. The unique ability of endolysins to rapidly cleave peptidoglycan in a generally species-specific manner renders them promising potential antibacterial agents. Endolysins from Listeria bacteriophages are promising tools for control of Listeria contamination. These proteins have a modular organization, which is characterized by an N-terminal localized enzymatically active domain (EAD), which contributes for the lytic activity of the endolysin, and a C-terminal localized cell wall binding domain (CBD), which targets the lysin to its substrate.

The use of bacteriophage-derived endolysins to control Listeria on food products has been suggested in literature and in patents. However, the effective use of endolysins to control and kill Listeria on high risk cheese products has not been previously demonstrated. Existing food grade anti-microbials such as nisin have not been effective for controlling Listeria on high risk cheeses, due to interference of the anti-microbial activity by the cheese composition, which appears to reduce or neutralize the activity of most anti-microbials.

It is an object of the present invention to provide an effective method for controlling Listeria on high risk cheese products using Listeria bacteriophage endolysins. The present invention resides in the use of novel endolysins with a pH optimum of about 6.0 or below with respect to their lytic activity to counter the interfering effect of cheese compositions, providing an effective way to protect high risk cheeses against Listeria contamination and growth. As an example of this technology, the endolysin PlyP40 of phage P40 is described. Information about this endolysin can be found in WO 2010/010192 (PCT/EP2009/059606).

Aspects of the invention are:

1. A method for controlling Listeria contamination of pasta filata cheese or a pasta filata cheese food product comprising applying a Listeria bacteriophage endolysin to pasta filata cheese or a pasta filata cheese food product.

2. A method for extending the shelf life of pasta filata cheese or a pasta filata cheese food product comprising applying a Listeria bacteriophage endolysin to pasta filata cheese or a pasta filata cheese food product.

3. The method of item 1 or 2, wherein the endolysin has a pH-optimum of 6.0 or below with regard to its lytic activity.

4. The method of any one of items 1 to 3, wherein the pasta filata cheese is mozzarella cheese, and wherein the pasta filata cheese food product is a mozzarella cheese food product.

5. The method of any one of items 1 to 4, further comprising applying to the pasta filata cheese or pasta filata cheese food product one or more Listeria-specific bacteriophages.

6. The method of any one of items 1 to 5, wherein the endolysin is encoded by a nucleic acid molecule comprising a polynucleotide selected from the group consisting of:

(a) a polynucleotide encoding a polypeptide having the amino acid sequence of SEQ ID NO: 2;

(b) a polynucleotide encoding a fragment, analog or functional derivative of a polypeptide encoded by the polynucleotide of (a), wherein said fragment, analog or functional derivative has endolysin activity;

(c) a polynucleotide comprising the nucleotide sequence of SEQ ID NO: 1;

(d) a polynucleotide comprising part of the nucleotide sequence of (c) and which encodes a fragment, analog or functional derivative of the polypeptide having the amino acid sequence of SEQ ID NO: 2, wherein said fragment, analog or functional derivative has endolysin activity; and

(e) a polynucleotide that is the complement of the full length of a polynucleotide of any of (a) to (d).

7. A food product comprising pasta filata cheese and a Listeria bacteriophage endolysin.

8. The food product of item 7, wherein the endolysin has a pH-optimum of 6.0 or below with regard to its lytic activity.

9. The food product of item 7 or 8, wherein the pasta filata cheese is mozzarella cheese.

10. The food product of any one of items 7 to 9, further comprising one or more Listeria-specific bacteriophages.

11. The food product of any one of items 7 to 10, wherein the endolysin is encoded by a nucleic acid molecule comprising a polynucleotide selected from the group consisting of:

(a) a polynucleotide encoding a polypeptide having the amino acid sequence of SEQ ID NO: 2;

(b) a polynucleotide encoding a fragment, analog or functional derivative of a polypeptide encoded by the polynucleotide of (a), wherein said fragment, analog or functional derivative has endolysin activity;

(c) a polynucleotide comprising the nucleotide sequence of SEQ ID NO: 1;

(d) a polynucleotide comprising part of the nucleotide sequence of (c) and which encodes a fragment, analog or functional derivative of the polypeptide having the amino acid sequence of SEQ ID NO: 2, wherein said fragment, analog or functional derivative has endolysin activity; and

(e) a polynucleotide that is the complement of the full length of a polynucleotide of any of (a) to (d).

12. A method of making the food product of item 7, comprising adding a Listeria bacteriophage endolysin to pasta filata cheese.

13. The method of item 11, wherein the endolysin has a pH-optimum of 6.0 or below with regard to its lytic activity.

14. The method of item 11 or 12, wherein the pasta filata cheese is mozzarella cheese.

15. The method of any one of items 12 to 14, further comprising adding one or more Listeria-specific bacteriophages to the pasta filata cheese.

16. The method of any one of items 11 to 15, wherein the endolysin is encoded by a nucleic acid molecule comprising a polynucleotide selected from the group consisting of:

(a) a polynucleotide encoding a polypeptide having the amino acid sequence of SEQ ID NO: 2;

(b) a polynucleotide encoding a fragment, analog or functional derivative of a polypeptide encoded by the polynucleotide of (a), wherein said fragment, analog or functional derivative has endolysin activity;

(c) a polynucleotide comprising the nucleotide sequence of SEQ ID NO: 1;

(d) a polynucleotide comprising part of the nucleotide sequence of (c) and which encodes a fragment, analog or functional derivative of the polypeptide having the amino acid sequence of SEQ ID NO: 2, wherein said fragment, analog or functional derivative has endolysin activity; and

(e) a polynucleotide that is the complement of the full length of a polynucleotide of any of (a) to (d).

### BRIEF DESCRIPTION OF THE DRAWINGS

FIG. 1 shows inhibition of growth of L. monocytogenes by endolysin PlyP40 over time after a Listeria monocytogenes inoculum comprising 1.5×10⁵ cfu was applied to slices of mozzarella cheese.

FIG. 2 shows inhibition of growth of L. monocytogenes by endolysin PlyP40 over time after a Listeria monocytogenes inoculum comprising 3.7×10² cfu was applied to slices of mozzarella cheese.

FIG. 3 shows the pH optimum of the endolysins PlyP40, PlyP825 and Ply511.

FIG. 4 shows inhibition of growth of L. monocytogenes by endolysin PlyP40, PlyP825 and Ply511 over time after a Listeria monocytogenes inoculum comprising 1.5×10⁵ cfu was applied to slices of mozzarella cheese. From left to right: control, Ply40, Ply825, and Ply511.

FIG. 5 shows inhibition of growth of L. monocytogenes by endolysin PlyP40, PlyP825 and Ply511 over time after a Listeria monocytogenes inoculum comprising 3.7×10² cfu was applied to slices of mozzarella cheese. From left to right: control, Ply40, Ply825, and Ply511.

FIG. 6 shows pH-profiling of endolysin GU3-825. Endolysin activity is analyzed by the incubation of killed off Listeria monocytogenes cell suspensions and measuring the decrease in OD₆₀₀ at 30° C.

FIG. 7 shows inhibition of growth of L. monocytogenes by endolysin PlyP40 and endolysin gu3-825 over time after a Listeria monocytogenes inoculum comprising 1.5×10⁵ cfu was applied to slices of mozzarella cheese. From left to right: control, PlyP40, GU3-825.

### DETAILED DESCRIPTION OF THE INVENTION

The present invention provides a method for controlling Listeria contamination of pasta filata cheese or a pasta filata cheese food product comprising applying a Listeria bacteriophage endolysin to pasta filata cheese or a pasta filata cheese food product. The present invention further provides a method for extending the shelf life of pasta filata cheese or a pasta filata cheese food product comprising applying a Listeria bacteriophage endolysin to pasta filata cheese or a pasta filata cheese food product. Still further, the present invention provides a food product comprising pasta filata cheese and a Listeria bacteriophage endolysin. In addition, the present invention provides a method of making the food product a food product comprising pasta filata cheese and a Listeria bacteriophage endolysin, comprising adding a Listeria bacteriophage endolysin to pasta filata cheese.

In the present invention, the Listeria bacteriophage endolysin is an endolysin that is encoded by a Listeria-specific bacteriophage. A Listeria-specific bacteriophage is an anti-Listeria bacteriophage. An endolysin to be used in the methods and food products of the present invention may be encoded by any Listeria-specific bacteriophage described herein. Preferably, an endolysin to be used in the methods and food products of the present invention is encoded by a Listeria monocytogenes-specific bacteriophage. More preferably, the endolysin to be used in the methods and food products of the present invention is endolysin PlyP40 (SEQ ID NO: 2) encoded by bacteriophage P40, described in international patent application WO 2010/010192 (PCT/EP2009/059606).

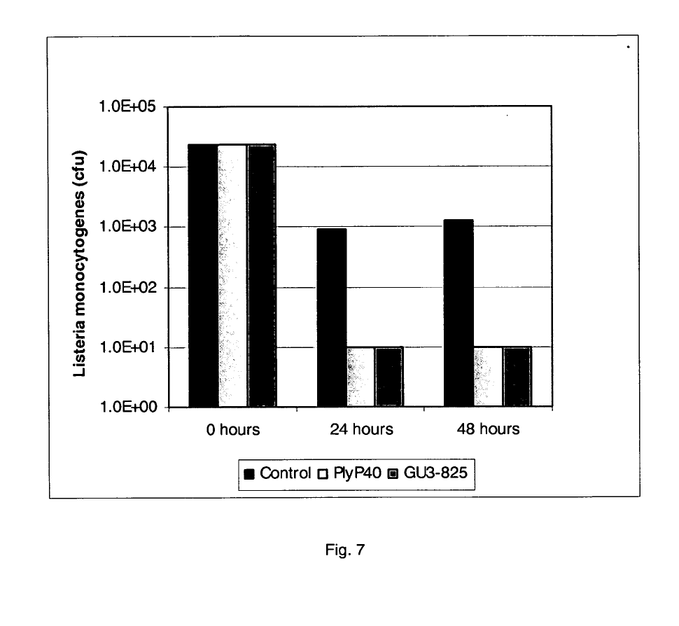

The nucleotide and amino acid sequence of the PlyP40 endolysin are shown in SEQ ID NOs: 1 and 2, respectively. A further characterization of the PlyP40 endolysin with regard to its EAD and CBD is given in FIG. 7 of WO 2010/010192 (PCT/EP2009/059606). Accordingly, the N-terminal amino acids from residue 1 (M1) to residue 200 (K200) of SEQ ID NO: 2 represent the EAD of PlyP40, while the C-terminal amino acids from residue 227 (T227) to residue 344 (K344) represent the CBD of PlyP40. The amino acid residues from position 201 (G201) to 226 (T226) represent a linker sequence.

The present invention encompasses bacteriophages of any Listeria species and serovars described herein elsewhere.

In the present invention, Listeria-specific bacteriophages are preferably Listeria monocytogenes-specific bacteriophages.

Characteristics of Endolysins Used in the Present Invention

In the present invention the term “endolysin” has the meaning that is common in the respective technical filed, i.e., denoting enzymes that are naturally encoded by bacteriophages and are produced by them at the end of their life cycle in the host to lyse the host cell and thereby release the progeny phages. Endolysins can also be produced, for instance, recombinantly by heterologous host cells. As described herein above, endolysins are comprised of at least one enzymatically active domain (EAD) and a non-enzymatically active cell (wall) binding domain (CBD). The EADs can exhibit different enzymatic activities as described herein, such as, e.g., N-acetyl-muramoyl-L-alanin amidase, (endo)-peptidase, transglycosylase, glycosyl hydrolase, (N-acetyl)-muramidase, or N-acetyl-glucosaminidase. The terms “endolysin(s)” and “lysin(s)” may be used herein interchangeably.

In the present invention, the endolysin preferably has a pH-optimum of about 6.0 or below with respect to its lytic activity. In various embodiments, the endolysin to be used in the methods and food products of the present invention has a pH-optimum in the range of about 3.0 to about 6.0, preferably in the range of about 3.5 to about 5.8, more preferably in the range of about 4.0 to about 5.7, even more preferably in the range of about 4.2 to about 5.6, most preferably in the range of about 4.5 to about 5.5. In various embodiments, the endolysin of the present invention has a pH-optimum of about 5.5 or below with respect to its lytic activity. In various embodiments, the endolysin of the present invention has a pH-optimum of about 4.5 or below with respect to its lytic activity.

Whenever reference is made to the lytic activity of an endolysin to be used in the methods and food products of the present invention, the lytic activity of the endolysin against Listeria bacterial cells is meant. Preferably, lytic activity against Listeria bacterial cells means lytic activity against pathogenic Listeria bacterial cells, more preferably against Listeria monocytogenes.

In the present invention, the lytic activity of an endolysin to be used in the methods and food products of the present invention is lytic activity against Listeria bacterial cells, preferably against pathogenic Listeria bacterial cells, more preferably against Listeria monocytogenes. More specifically, the lytic activity of an endolysin to be used in the methods and food products of the present invention is hydrolytic activity. More specifically, the lytic activity of an endolysin to be used in the methods and food products of the present invention is hydrolytic activity against peptidoglycan in the cell wall of Listeria bacterial cells. Therefore, the lytic activity of an endolysin to be used in the methods and food products of the present invention may also be described as peptidoglycan hydrolase activity or peptidoglycan hydrolytic activity.

As used herein, the EAD of an endolysin encompassed by the present invention has lytic activity against Listeria bacterial cells. In particular, the lytic activity of an EAD of an endolysin encompassed by the present invention is defined as lytic activity against Listeria bacterial cells. More specifically, the enzymatic activity of an endolysin encompassed by the present invention is analogous to the enzymatic activity of known EADs exhibiting lytic activity against Listeria bacterial cells. Given the fact that EADs from Listeria bacteriophages are known and described in the art, the nature of the lytic activity of the EAD of an endolysin encompassed by the present invention is clear to the skilled person. In various embodiments of the present invention, the lytic activity of the EAD of an endolysin encompassed by the present invention against Listeria bacterial cells is peptidoglycan hydrolase activity, i.e. hydrolytic activity against peptidoglycan in the cell wall of Listeria bacterial cells. The peptidoglycan hydrolase activity of the EAD of an endolysin encompassed by the present invention may also be called peptidoglycan-digesting activity or muralytic activity. In various embodiments, the lytic activity of the EAD of an endolysin encompassed by the present invention is muramidase activity or N-Acteyl-glucosaminidase activity. In various further embodiments, the lytic activity of the EAD of an endolysin encompassed by the present invention is amidase activity or endopeptidase activity. Preferably, the lytic activity of the EAD of an endolysin encompassed by the present invention is peptidoglycan amidase activity. More preferably, the lytic activity of the EAD of an endolysin encompassed by the present invention is L-muramoyl-L-alanine amidase activity, D-alanyl-glycyl endopeptidase activity, or D-6-meso-DAP-peptidase or meso-DAP-D-Ala peptidase activity. In various embodiments, the lytic activity of the EAD of an endolysin encompassed by the present invention is peptidoglycan transglycosylase activity. More preferably, the lytic activity of the EAD of an endolysin encompassed by the present invention is murein transglycosylase activity. In various embodiments, the lytic activity of the EAD of an endolysin encompassed by the present invention is peptidase activity, preferably carboxypeptidase activity. In various embodiments, the lytic activity of the EAD of an endolysin encompassed by the present invention is glycosyl hydrolase activity. In various further embodiments, the lytic activity of the EAD of an endolysin encompassed by the present invention is N-acetylmuramoyl-L-alanine amidase activity. In various embodiments, the lytic activity of the EAD of an endolysin encompassed by the present invention is cysteine histidine-dependent amidohydrolase/peptidase activity.

As described herein, a CBD of an endolysin encompassed by the present invention has cell wall binding activity. This cell wall binding activity provides for targeting the lysin to its substrate, namely the peptidoglycan of Listeria bacterial cells. Therefore, in particular the cell wall binding activity of the CBD of an endolysin encompassed by the present invention is Listeria cell wall binding activity. It is clear to the skilled person that CBDs according to the present invention have no or no significant hydrolytic activity like the EADs, i.e. CBDs according to the present invention have no or no significant hydrolytic activity against Listeria bacterial cell walls. Here, no or no significant hydrolytic activity is intended to describe the situation whereby the hydrolytic activity of a CBD of the present invention is not sufficient to prevent the application of such a CBD to bind to the cell wall of a Listeria bacterial cell. A CBD according to the present invention is supposed to be a protein, which has no or no significant hydrolytic activity itself.

In various embodiments, the cell wall binding activity of the CBD of an endolysin encompassed by the present invention is binding to peptidoglycan of the cell wall of Listeria bacterial cells. Preferably, the cell wall binding activity of the CBD of an endolysin encompassed by the present invention is binding to a carbohydrate or cholin moiety in the cell wall of Listeria bacterial cells. More preferably, the cell wall binding activity of the CBD of an endolysin encompassed by the present invention is binding to a carbohydrate of the peptidoglycan or teichoic acid or lipoteichoic acid in the cell wall of Listeria bacterial cells.

Variants

In the present invention, an endolysin to be used in the present invention encompasses any of the variants described herein.

The present invention encompasses the use/application of a fragment, analog or functional derivative of any Listeria bacteriophage endolysin encompassed by the present invention, wherein such a fragment, analog or functional derivative exhibits endolysin activity in accordance with the present invention. The definition of endolysin activity according to the present invention is given elsewhere herein. Preferably, an endolysin to be used/applied in the present invention has the endolysin activity of the polypeptide encoded by the amino acid sequence of SEQ ID NO: 2.

Fragments of any of the endolysins encompassed by the present invention include, but are not limited to, lytic domains (i.e., EADs) of any endolysin described herein. Furthermore, fragments of any of the endolysins encompassed by the present invention include, but are not limited to, cell wall binding domains (i.e., CBDs) of any endolysin described herein.

Furthermore, endolysins to be used/applied in the present invention also include combinations of proteins as described herein elsewhere. Still further, endolysins to be used/applied in the present invention also include chimeric proteins as described herein elsewhere.

Endolysin Molecule gu3-825

The present invention encompasses the endolysin designated gu3-825 and its use in the methods and food products of the present invention. The endolysin gu3-825 is encoded by the nucleotide and amino acid sequence of SEQ ID NO: 5 and 6, respectively. The endolysin gu3-825 encompasses two enzymatically active domains (EADs) and one cell wall binding domain (CBD). The first EAD comprises amino acid residues 1 to 236 of SEQ ID NO: 6. The second EAD comprises amino acid residues 401 to 547 of SEQ ID NO: 6. The CBD comprises amino acid residues 237 to 400 of SEQ ID NO: 6. The novel endolysin gu3-825 is an artificially synthesized molecule. The novel endolysin gu3-825 may be considered as a variant endolysin or a chimeric endolysin protein according to the present invention. The endolysin gu3-825 is based on the EAD of endolysin PlyP40 (first EAD of gu3-825), the EAD of endolysin PlyP825 (the second EAD of gu3-825), and the CBD of endolysin Ply511. With respect to its lytic activity, the novel endolysin gu3-825 has a pH optimum below pH 6, and is therefore particularly useful in controlling Listeria on pasta filata cheese, which means that this molecule is particularly useful in the methods and food products of the present invention. This is shown in the examples of the present invention.

Pasta Filata Cheese

Pasta filata is one of most popular cheeses in the world. The most well known pasta filata is mozzarella. Typical pasta filata cheeses are Bocconcini, Burrata, Caciotta, Caciocavallo, Fior di Latte, Girellone, Girellone farcito, Mozzarella, Palermitano, Perette bianche, Perette affumicate, Perette filoncini, Provolone, Ragusano, Scamorza, Tenerella, and Trecce. Accordingly, in various embodiments of the present invention the pasta filata cheese is any one of Bocconcini, Burrata, Caciotta, Caciocavallo, Fior di Latte, Girellone, Girellone farcito, Mozzarella, Palermitano, Perette bianche, Perette affumicate, Perette filoncini, Provolone, Ragusano, Scamorza, Tenerella, and Trecce cheese. Preferably, the pasta filata cheese is mozzarella cheese. In various embodiments, the mozzarella cheese is buffalo mozzarella, i.e., mozzarella made from buffalo's milk. In various other embodiments, the mozzarella cheese is made from cow's milk.

In the present invention, a pasta filata cheese food product may be described as a pasta filata cheese-based food product or a food product comprising or containing pasta filata cheese. In various embodiments of the present invention the pasta filata cheese food product is a food product comprising cheese selected from any one of Bocconcini, Burrata, Caciotta, Caciocavallo, Fior di Latte, Girellone, Girellone farcito, Mozzarella, Palermitano, Perette bianche, Perette affumicate, Perette filoncini, Provolone, Ragusano, Scamorza, Tenerella, and Trecce cheese. In various embodiments, the pasta filata cheese food product is a mozzarella cheese food product. Preferably, the mozzarella cheese is buffalo mozzarella, i.e., mozzarella made from buffalo's milk. In various other embodiments, the mozzarella cheese is made from cow's milk.

Also encompassed by the present invention are pasta filata-like cheeses, which may be produced by modified processes for producing pasta filata cheese. Accordingly, in various embodiments the pasta filata cheese is a pasta filata-like cheese.

In particular encompassed by the present invention are mozzarella-like cheeses, which may be produced by modified processes for producing mozzarella cheese described in the art. Accordingly, in various embodiments the mozzarella cheese is a mozzarella-like cheese.

Also encompassed by the present invention are so-called process cheese and imitation cheese to the extent that such cheeses comprise pasta filata cheese. Accordingly, in various embodiments the pasta filata cheese is a process cheese or an imitation cheese to the extent that such cheeses comprise pasta filata cheese as described herein. In various preferred embodiments the pasta filata cheese is a process cheese or an imitation cheese to the extent that such cheeses comprise mozzarella cheese as described herein.

Also encompassed by the present invention are varieties of pasta filata cheeses described herein, like, e.g., low-fat or non-fat pasta filata cheeses. Accordingly, in various embodiments the pasta filata cheese is a variety of a pasta filata cheese described herein. In various preferred embodiments the pasta filata cheese is a variety of a mozzarella cheese as described herein.

Also encompassed by the present invention are pasta filata-like cheeses and pasta filata-like cheese products. Accordingly, in various embodiments the pasta filata cheese or pasta filata cheese product described herein is a pasta filata-like cheese or a pasta filata-like cheese product. In various preferred embodiments the pasta filata-like cheese or pasta filata-like cheese product is a mozzarella-like cheese or a mozzarella-like cheese product, respectively.

Also encompassed by the present invention are pasta filata-simulative cheeses. Accordingly, in various embodiments the pasta filata cheese described herein is a pasta filata-simulative cheese. In various preferred embodiments the pasta filata cheese is a mozzarella-simulative cheese.

Also encompassed by the present invention are pasta filata cheeses that are functionally and organoleptically simulative of pasta filata cheeses. Accordingly, in various embodiments the pasta filata cheese described herein is a pasta filata cheese that is functionally and organoleptically simulative of a pasta filata cheese. In various preferred embodiments the pasta filata cheese is a mozzarella cheese that is functionally and organoleptically simulative of a pasta filata cheese.

As described in the background section, pasta filata is a technique in the manufacture of a family of cheeses, which are also known in English as stretched-curd, pulled-curd, and plastic-curd cheeses. Therefore, in the present invention “pasta filata cheese” may also be designated as “stretched-curd cheese”, “pulled-curd cheese”, and/or “plastic-curd cheese”. Accordingly, the term “pasta filata cheese” on the one hand, and “stretched-curd cheese”, “pulled-curd cheese”, and “plastic-curd cheese”, respectively, on the other hand may be used herein interchangeably.

In various embodiments, the pasta filata cheese food product described herein is a packaged pasta filata cheese food product. Preferably, the pasta filata cheese is a mozzarella cheese and the cheese food product is a packaged mozzarella cheese food product.

In various embodiments, the pasta filata cheese or the pasta filata cheese food product is contained in a sealed package.

In various embodiments, the pasta filata cheese or the pasta filata cheese food product is packaged and/or stored under refrigeration conditions, preferably at 4° C. (or 39° F.).

In various embodiments, the pasta filata cheese or the pasta filata cheese food product is packaged and/or stored under freeze conditions, preferably under deep-freeze conditions, more preferably at −18° C. (−0.4° F.), or at −20° C. (−4° F.).

In various embodiments, the pasta filata cheese or the pasta filata cheese food product is contained in a sealed package and stored under refrigeration conditions, preferably at 4° C. (or 39° F.).

In various embodiments, the pasta filata cheese or the pasta filata cheese food product is contained in a sealed package and stored under freeze conditions, preferably under deep-freeze conditions, more preferably at −18° C. (−0.4° F.), or at −20° C. (−4° F.).

In various embodiments, the pasta filata cheese or the pasta filata cheese food product is packaged and/or stored under non-air conditions, preferably under CO₂ atmosphere, or under N₂ atmosphere.

Controlling Listeria in Pasta Filata Cheese

The present invention relates to the use of Listeria bacteriophage endolysins for controlling Listeria contamination of pasta filata cheese or a pasta filata cheese food product. Accordingly, the present invention provides a method for controlling Listeria contamination of pasta filata cheese or a pasta filata cheese food product comprising applying a Listeria bacteriophage endolysin to pasta filata cheese or a pasta filata cheese food product. The present invention further relates to the use of Listeria bacteriophage endolysins for extending the shelf life of pasta filata cheese or a pasta filata cheese food product. Accordingly, the present invention further provides a method for extending the shelf life of pasta filata cheese or a pasta filata cheese food product comprising applying a Listeria bacteriophage endolysin to pasta filata cheese or a pasta filata cheese food product. These methods and uses of the present invention are characterized in that Listeria bacteriophage endolysins are applied to pasta filata cheese or a pasta filata cheese food product.

In various embodiments, applying Listeria bacteriophage endolysins to pasta filata cheese serves for controlling Listeria contamination of pasta filata cheese contaminated with Listeria bacteria or pasta filata cheese supposed to be contaminated with Listeria bacteria. Furthermore, in various embodiments applying Listeria bacteriophage endolysins to a pasta filata cheese product serves for controlling Listeria contamination of a pasta filata cheese food product contaminated with Listeria bacteria or a pasta filata cheese food product supposed to be contaminated with Listeria bacteria.

In various embodiments, Listeria bacteriophage endolysins are applied to pasta filata cheese for preventing contamination of the cheese with Listeria bacteria. Furthermore, in various embodiments Listeria bacteriophage endolysins are applied to pasta filata cheese products for preventing contamination of the cheese food products with Listeria bacteria. Therefore, in the present invention controlling Listeria contamination of pasta filata cheese or a pasta filata cheese food product includes preventing Listeria contamination of pasta filata cheese or a pasta filata cheese food product. Accordingly, the present invention provides a method for preventing Listeria contamination of pasta filata cheese or a pasta filata cheese food product comprising applying a Listeria bacteriophage endolysin to pasta filata cheese or a pasta filata cheese food product.

In the present invention, controlling Listeria contamination includes suppressing or inhibiting growth of Listeria bacteria in or on pasta filata cheese or a pasta filata cheese food product. Furthermore, in the present invention controlling Listeria contamination includes killing Listeria bacteria in or on pasta filata cheese or a pasta filata cheese food product according to the present invention. Still further, in the present invention controlling Listeria contamination includes eradicating or removing undesired colonization of Listeria bacteria in or on pasta filata cheese or a pasta filata cheese food product according to the present invention.

In various embodiments, applying a Listeria bacteriophage endolysin to pasta filata cheese or a pasta filata cheese food product includes incubating the pasta filata cheese or the pasta filata cheese food product with a Listeria bacteriophage endolysin. The conditions for incubation according to the present invention can be determined by the one of skill in the art, That is, incubation is performed under conditions such that a successful reduction of the Listeria contamination is achieved or the amount of Listeria bacteria is substantially reduced in pasta filata cheese or a pasta filata cheese food product according to the present invention.

In the present invention, incubation of a pasta filata cheese or a pasta filata cheese food product with a Listeria bacteriophage endolysin in order to control Listeria contamination of a pasta filata cheese or a pasta filata cheese food product according to the present invention also includes the storage of a pasta filata cheese or a pasta filata cheese food product after manufacture and/or packaging of the pasta filata cheese or a pasta filata cheese food product. That is, in the present invention the conditions of storage of a pasta filata cheese or a pasta filata cheese food product until consumption by the consumer are conditions of incubation according to the present invention, i.e. conditions of incubation of a pasta filata cheese or a pasta filata cheese food product in order to control Listeria contamination of a pasta filata cheese or a pasta filata cheese food product according to the present invention.

Extending the Shelf Life of Pasta Filata Cheese or a Pasta Filata Cheese Food Product

The present invention also relates to the use of Listeria bacteriophage endolysins for extending the shelf life of pasta filata cheese or a pasta filata cheese food product. Accordingly, the present invention provides a method for extending the shelf life of pasta filata cheese or a pasta filata cheese food product comprising applying a Listeria bacteriophage endolysin to pasta filata cheese or a pasta filata cheese food product. These methods and uses of the present invention are also characterized in that Listeria bacteriophage endolysins are applied to pasta filata cheese or a pasta filata cheese food product.

Food products should not contain microorganisms, their toxins, or metabolites in quantities that present an unacceptable risk for human health. Regulations set down general food safety requirements, according to which food must not be placed on the market if it is unsafe. The microbiological safety is an integral part of food safety. The shelf life of food products is characterized as the time period during which food products maintain their microbiological safety. The shelf life of perishable food products is based on the survival and growth of spoilage microorganisms but can also include pathogenic survival and growth.

Food business operators can exert significant control over safety and shelf life of food products through careful selection of raw materials/ingredients, the processing they receive and how they are packaged and stored. Therefore, the shelf life is directly affected by the microbiological safety of food products. Variation in the microbiological safety will affect the safety of food products and the shelf life.

The present application demonstrates that a Listeria bacteriophage endolysin can be used for controlling Listeria contamination of pasta filata cheese. In particular, it is shown that survival and growth of Listeria bacteria is inhibited on pasta filata cheese treated with a Listeria bacteriophage endolysin as compared to untreated pasta filata cheese. This inhibition directly affects the shelf life of pasta filata cheese and pasta filata cheese food products because survival and growth of Listeria bacteria is inhibited, which means that microbiological safety is maintained. Therefore, the present invention provides a starting point for producing safe food products having an extended shelf life by applying Listeria bacteriophage endolysin to pasta filata cheese or pasta filata cheese food products.

In various embodiments, applying Listeria bacteriophage endolysins to pasta filata cheese or pasta filata cheese food products prevents contamination of the cheese or the cheese food product with Listeria bacteria, thereby extending the shelf life of pasta filata cheese or pasta filata cheese food products according to the present invention.

In various embodiments, applying Listeria bacteriophage endolysins to pasta filata cheeses or pasta filata cheese food products suppresses or inhibits growth of Listeria bacteria, thereby extending the shelf life of pasta filata cheeses or pasta filata cheese food products according to the present invention.

In various embodiments, applying Listeria bacteriophage endolysins to pasta filata cheeses or pasta filata cheese food products kills Listeria bacteria, thereby extending the shelf life of pasta filata cheeses or pasta filata cheese food products according to the present invention.

In various embodiments, applying Listeria bacteriophage endolysins to pasta filata cheese serves for extending the shelf life of pasta filata cheese that is at risk of being contaminated with Listeria bacteria or pasta filata cheese supposed to be contaminated with Listeria bacteria. Furthermore, in various embodiments applying Listeria bacteriophage endolysins to a pasta filata cheese product serves for extending the shelf life of a pasta filata cheese food product at risk of being contaminated with Listeria bacteria or a pasta filata cheese food product supposed to be contaminated with Listeria bacteria.

In various embodiments, applying a Listeria bacteriophage endolysin to a pasta filata cheese or a pasta filata cheese food product in order to extend the shelf life of a pasta filata cheese or a pasta filata cheese food product according to the present invention includes incubating the pasta filata cheese or the pasta filata cheese food product with a Listeria bacteriophage endolysin. The conditions for incubation according to the present invention can be determined by the one of skill in the art. In various embodiments, incubation is performed under conditions such that the shelf life of the pasta filata cheese or the pasta filata cheese food product is successfully extended, i.e. the shelf life is extended as compared to pasta filata cheese or a pasta filata cheese food product that is not applied or incubated with a Listeria bacteriophage endolysin according to the present invention.

In the present invention, incubation of a pasta filata cheese or a pasta filata cheese food product with a Listeria bacteriophage endolysin in order to extend the shelf life of a pasta filata cheese or a pasta filata cheese food product according to the present invention also includes the storage of a pasta filata cheese or a pasta filata cheese food product after manufacture and packaging of the pasta filata cheese or a pasta filata cheese food product. That is, in the present invention the conditions of storage of a pasta filata cheese or a pasta filata cheese food product until consumption by the consumer are conditions of incubation according to the present invention, i.e. conditions of incubation of a pasta filata cheese or a pasta filata cheese food product in order to extend the shelf life of a pasta filata cheese or a pasta filata cheese food product according to the present invention.

In various embodiments, extending the shelf life of a pasta filata cheese or a pasta filata cheese food product is achieved if reduction of the Listeria contamination is achieved or the amount of Listeria bacteria is substantially reduced in pasta filata cheese or a pasta filata cheese food product according to the present invention.

In various embodiments, the Listeria bacteriophage endolysin is effective to limit growth of Listeria bacteria to less than 3 logs, preferably 2 logs, more preferably 1 log, throughout the shelf life of a pasta filata cheese or a pasta filata cheese food product according to the present invention.

In various embodiments, the Listeria bacteriophage endolysin is effective to inhibit growth of Listeria bacteria in a pasta filata cheese or a pasta filata cheese food product according to the present invention for about 48 hours when stored at a temperature of about 15° C.

Combinations of Endolysin Proteins with Known Listeria-Specific Phages

Encompassed by the present invention is the combination of endolysins encompassed by the present invention with one or more Listeria-specific bacteriophages described in the art. Such combinations can be used in methods for controlling Listeria contamination or extending the shelf life of a pasta filata cheese or a pasta filata cheese food product according to the present invention. Accordingly, in various embodiments the methods for controlling Listeria contamination and for extending the shelf life of a pasta filata cheese or a pasta filata cheese food product according to the present invention further comprise applying to the pasta filata cheese or pasta filata cheese food product one or more Listeria-specific bacteriophages.

Combinations of Endolysins with Known Lytic Domains

Further encompassed by the present invention is the combination of endolysins encompassed by the present invention with one or more lytic domains (i.e., EADs) of endolysins from other Listeria-specific bacteriophages described in the art. Such combinations can be used for controlling Listeria contamination and extending the shelf life of a pasta filata cheese or a pasta filata cheese food product according to the present invention. Based on sequence homology the skilled person is able to determine the lytic domains of endolysins encoded by known phages.

Also encompassed by the present invention is the combination of endolysins encompassed by the present invention with one or more lytic domains of autolysins described in the art. Autolysins are bacteriolytic enzymes that digest the cell-wall peptidoglycan of the bacteria that produce them. Autolysins are involved in cell wall reconstruction during bacterial cell division. Such combinations can be used for controlling Listeria contamination and extending the shelf life of a pasta filata cheese or a pasta filata cheese food product according to the present invention.

Also encompassed by the present invention is the combination of endolysins encompassed by the present invention with one or more lytic domains of bacteriocins described in the art. Bacteriocins are molecules also produced and secreted by microorganisms. They are antibacterial substances of a proteinaceous nature that are produced by different bacterial species. A subclass of bacteriocins consists of enzymes (proteinaceous toxins) which are produced by bacteria to inhibit the growth of similar or closely related concurrence bacterial strain(s) in their habitat. Many bacteria produce antimicrobial bacteriocin peptides. Such combinations can be used for controlling Listeria contamination and extending the shelf life of a pasta filata cheese or a pasta filata cheese food product according to the present invention.

Also encompassed by the present invention is the combination of endolysins encompassed by the present invention with one or more antimicrobial peptides. Antimicrobial peptides are ubiquitous, gene-encoded natural antibiotics that have gained recent attention in the search for new antimicrobials to combat infectious disease. Antimicrobial peptides generally have a length between 12 and 50 amino acids. The amphipathicity of the antimicrobial peptides allows to partition into the membrane lipid bilayer. The ability to associate with membranes is a definitive feature of antimicrobial peptides. Such combinations can be used for controlling Listeria contamination and extending the shelf life of a pasta filata cheese or a pasta filata cheese food product according to the present invention.

Combinations of Endolysins with Cell Wall Binding Domains

Further encompassed by the present invention is the combination of endolysins encompassed by the present invention with one or more cell wall binding domains of endolysins from Listeria bacteriophages described in the art. Such combinations can be used for controlling Listeria contamination and extending the shelf life of a pasta filata cheese or a pasta filata cheese food product according to the present invention. As for the lytic domain encoded by the endolysins from known phages, based on sequence homology the skilled person is able to determine the cell wall binding domain of the endolysins encoded by known phages.

Also encompassed by the present invention is the combination of endolysins encompassed by the present invention with one or more cell wall binding domains of autolysins known in the art. Such combinations can be used for controlling Listeria contamination and extending the shelf life of a pasta filata cheese or a pasta filata cheese food product according to the present invention. Based on sequence homology the skilled person is able to determine the cell wall binding domain of autolysins known in the art.

Also encompassed by the present invention is the combination of endolysins encompassed by the present invention with one or more cell wall binding domains of bacteriocins described in the art. Such combinations can be used for controlling Listeria contamination and extending the shelf life of a pasta filata cheese or a pasta filata cheese food product according to the present invention. Based on sequence homology the skilled person is able to determine the cell wall binding domain of the bacteriocins known in the art.

Combinations of Endolysins Encompassed by the Present Invention

Also encompassed by the present invention is the combination of endolysins encompassed by the present invention, i.e. the combination of two or more Listeria bacteriophage endolysins, preferably two or more Listeria bacteriophage endolysins having a pH optimum of 6.0 or below with respect to their lytic activity. Such combinations can be used for controlling Listeria contamination and extending the shelf life of a pasta filata cheese or a pasta filata cheese food product according to the present invention.

Chimeric Proteins

Further encompassed by the present invention are chimeric proteins comprising an endolysin encompassed by the present invention and one or more heterologous proteins. In various embodiments, the heterologous protein is a heterologous endolysin protein. In various other embodiments, the heterologous protein is the lytic domain or cell wall binding domain of a heterologous endolysin protein.

Also encompassed by the present invention are chimeric proteins comprising an endolysin encompassed by the present invention and one or more lytic domains (i.e., EADs) and/or one or more cell wall binding domains (i.e., CBDs) of known endolysins from Listeria bacteriophages known in the art.

In various embodiments, the chimeric proteins to be used/applied in the present invention comprise more than one endolysin encompassed by the present invention. That is, chimeric proteins to be used/applied in the present invention may comprise tandem repeats of one or more endolysins encompassed by the present invention.

Combined Treatment

The present invention provides a combined treatment for controlling Listeria contamination in pasta filata cheese or a pasta filata cheese food product, which comprises applying an endolysin encompassed by the present invention and a further/additional anti-Listeria agent to the cheese or cheese food product. Furthermore, the present invention provides a combined treatment for extending the shelf life of pasta filata cheese or a pasta filata cheese food product, which comprises applying an endolysin encompassed by the present invention and a further/additional anti-Listeria agent to the cheese or cheese food product. For both combined treatments described the further/additional anti-Listeria agent is non-toxic to humans and animals. Preferably, the further/additional anti-Listeria agent is an antimicrobial agent effective against Listeria bacteria, or an enzyme, both of which being non-toxic to humans and animals.

The further/additional anti-Listeria agent may be applied to the pasta filata cheese or a pasta filata cheese food product before, concomitantly with, or after applying an endolysin according to the present invention.

Further encompassed by the present invention is a combined treatment for controlling Listeria contamination in cheese, which comprises applying an endolysin encompassed by the present invention and an irradiation treatment to pasta filata cheese or a pasta filata cheese food product contaminated with Listeria bacteria, or supposed to be contaminated with Listeria bacteria. Also encompassed by the present invention is a combined treatment for extending the shelf life of pasta filata cheese or a pasta filata cheese food product, which comprises applying an endolysin encompassed by the present invention and an irradiation treatment to pasta filata cheese or a pasta filata cheese food product contaminated with Listeria bacteria, or supposed to be contaminated with Listeria bacteria. As used herein, irradiation treatment means subjecting pasta filata cheese or a pasta filata cheese food product contaminated with Listeria bacteria, or supposed to be contaminated with Listeria bacteria, to ionizing radiation, also called ionizing energy. The radiation used to treat the pasta filata cheese or pasta filata cheese food product contaminated with Listeria bacteria, or supposed to be contaminated with Listeria bacteria, may be applied before or after the endolysin is applied to the cheese or cheese food product.

Further encompassed by the present invention is a combined treatment for controlling Listeria contamination in cheese, which comprises applying an endolysin protein as described herein and high intensity light emission treatment to cheese contaminated with Listeria bacteria, or supposed to be contaminated with Listeria bacteria. Also encompassed by the present invention is a combined treatment for extending the shelf life of pasta filata cheese or a pasta filata cheese food product, which comprises applying an endolysin encompassed by the present invention and high intensity light emission treatment to a pasta filata cheese or a pasta filata cheese food product contaminated with Listeria bacteria, or supposed to be contaminated with Listeria bacteria. Specifically, high intensity light emission treatment may be performed by a pulsed power source, as described in MacGregor et al. 1998 (“Light inactivation of food-related pathogenic bacteria using a pulsed power source”, Letters in Applied Microbiology 27(2):67-70). The high intensity light emission treatment may be applied to a pasta filata cheese or a pasta filata cheese food product contaminated with Listeria bacteria, or supposed to be contaminated with Listeria bacteria, before or after the endolysin is applied to the cheese or cheese food product.

In various embodiments, the pasta filata cheese or pasta filata cheese food product according to the present invention further comprises a further/additional anti-microbial agent. Here, the further/additional antimicrobial agent preferably is an antimicrobial agent effective against Listeria bacteria or other pathogenic bacteria.

In various embodiments, the pasta filata cheese or pasta filata cheese food product of the present invention has undergone thermal treatment prior to introducing/adding an endolysin according to the present invention to the cheese or cheese food product. Specifically, thermal treatment of the pasta filata cheese or pasta filata cheese food product of the present invention is heat treatment of the cheese food or cheese food product of the present invention, more preferably heat treatment at a temperature of at least 70° C., or 71° C. Still more preferably, thermal treatment is heat treatment at a temperature of at least 72° C., or 73° C. Even more preferably, thermal treatment is heat treatment at a temperature of at least 74° C., or 75° C. Preferably, the thermal/heat treatment is applied during the manufacturing process of the pasta filata cheese or the pasta filata cheese food product. In various embodiments, the thermal/heat treatment is applied to the raw or starting material used in the manufacturing process.

PlyP40 Nucleic Acid and Amino Acid Sequences and Variants Thereof

In a preferred embodiment, the endolysin used in the present invention is encoded by a nucleic acid sequence that encodes a polypeptide having the amino acid sequence of SEQ ID NO: 2. Further encompassed by the present invention is an endolysin, which is encoded by a nucleic acid sequence that is at least 80% or at least 85% identical to the nucleic acid sequence encoding a polypeptide having the amino acid sequence of SEQ ID NO: 2, and that encodes a polypeptide having the endolysin activity of the endolysin of SEQ ID NO: 2. Still further encompassed by the present invention is an endolysin, which is encoded by a nucleic acid sequence that is at least 90% or at least 95% identical to the nucleic acid sequence encoding a polypeptide having the amino acid sequence of SEQ ID NO: 2, and that encodes a polypeptide having the endolysin activity of the endolysin of SEQ ID NO: 2. In various embodiments, the endolysin used in the present invention is an endolysin, which is encoded by a nucleic acid sequence that is at least 96% or at least 97% identical to the nucleic acid sequence encoding a polypeptide having the amino acid sequence of SEQ ID NO: 2, and that encodes a polypeptide having the endolysin activity of the endolysin of SEQ ID NO: 2. In various other embodiments, the endolysin used in the present invention is an endolysin, which is encoded by a nucleic acid sequence that is at least 98% or at least 99% identical to the nucleic acid sequence encoding a polypeptide having the amino acid sequence of SEQ ID NO: 2, and that encodes a polypeptide having the endolysin activity of the endolysin of SEQ ID NO: 2.

Furthermore, in a preferred embodiment the endolysin used in the present invention comprises a polypeptide having the amino acid sequence of SEQ ID NO: 2. Further encompassed by the present invention is an endolysin, which comprises a polypeptide having an amino acid sequence that is at least 80% or at least 85% identical to the amino acid sequence of SEQ ID NO: 2, and which has the endolysin activity of the endolysin of SEQ ID NO: 2. Still further encompassed by the present invention is an endolysin, which comprises a polypeptide having an amino acid sequence that is at least 90% or at least 95% identical to the amino acid sequence of SEQ ID NO: 2, and which has the endolysin activity of the endolysin of SEQ ID NO: 2. In various embodiments, the endolysin used in the present invention comprises a polypeptide having an amino acid sequence that is at least 96% or at least 97% identical to the amino acid sequence of SEQ ID NO: 2, and which has the endolysin activity of the endolysin of SEQ ID NO: 2. In various other embodiments, the endolysin used in the present invention comprises a polypeptide having an amino acid sequence that is at least 98% or at least 99% identical to the amino acid sequence of SEQ ID NO: 2, and which has the endolysin activity of the endolysin of SEQ ID NO: 2.

In a preferred embodiment the endolysin used in the present invention is encoded by a nucleic acid molecule comprising a polynucleotide having the nucleotide sequence of SEQ ID NO: 1.

Further encompassed by the present invention is an endolysin, which is encoded by a nucleic acid molecule, which comprises a polynucleotide that is at least 80% or at least 85% identical to the nucleotide sequence of SEQ ID NO: 1, and that encodes a polypeptide having the endolysin activity of the endolysin of SEQ ID NO: 2. Still further encompassed by the present invention is an endolysin, which is encoded by a nucleic acid molecule, which comprises a polynucleotide that is at least 90% or at least 95% identical to the nucleotide sequence of SEQ ID NO: 1, and that encodes a polypeptide having the endolysin activity of the endolysin of SEQ ID NO: 2. In various embodiments, the endolysin used in the present invention is an endolysin, which is encoded by a nucleic acid molecule, which comprises a polynucleotide that is at least 96% or at least 97% identical to the nucleotide sequence of SEQ ID NO: 1, and that encodes a polypeptide having the endolysin activity of the endolysin of SEQ ID NO: 2. In various other embodiments, the endolysin used in the present invention is an endolysin, which is encoded by a nucleic acid molecule, which comprises a polynucleotide that is at least 98% or at least 99% identical to the nucleotide sequence of SEQ ID NO: 1, and that encodes a polypeptide having the endolysin activity of the endolysin of SEQ ID NO: 2.

Gu3-825 Nucleic Acid and Amino Acid Sequences and Variants Thereof

In various embodiments, the endolysin used in the present invention is encoded by a nucleic acid sequence that encodes a polypeptide having the amino acid sequence of SEQ ID NO: 6. Further encompassed by the present invention is an endolysin, which is encoded by a nucleic acid sequence that is at least 80% or at least 85% identical to the nucleic acid sequence encoding a polypeptide having the amino acid sequence of SEQ ID NO: 6, and that encodes a polypeptide having the endolysin activity of the endolysin of SEQ ID NO: 6. Still further encompassed by the present invention is an endolysin, which is encoded by a nucleic acid sequence that is at least 90% or at least 95% identical to the nucleic acid sequence encoding a polypeptide having the amino acid sequence of SEQ ID NO: 6, and that encodes a polypeptide having the endolysin activity of the endolysin of SEQ ID NO: 6. In various embodiments, the endolysin used in the present invention is an endolysin, which is encoded by a nucleic acid sequence that is at least 96% or at least 97% identical to the nucleic acid sequence encoding a polypeptide having the amino acid sequence of SEQ ID NO: 6, and that encodes a polypeptide having the endolysin activity of the endolysin of SEQ ID NO: 6. In various other embodiments, the endolysin used in the present invention is an endolysin, which is encoded by a nucleic acid sequence that is at least 98% or at least 99% identical to the nucleic acid sequence encoding a polypeptide having the amino acid sequence of SEQ ID NO: 6, and that encodes a polypeptide having the endolysin activity of the endolysin of SEQ ID NO: 6.

Furthermore, in a preferred embodiment the endolysin used in the present invention comprises a polypeptide having the amino acid sequence of SEQ ID NO: 6. Further encompassed by the present invention is an endolysin, which comprises a polypeptide having an amino acid sequence that is at least 80% or at least 85% identical to the amino acid sequence of SEQ ID NO: 6, and which has the endolysin activity of the endolysin of SEQ ID NO: 6. Still further encompassed by the present invention is an endolysin, which comprises a polypeptide having an amino acid sequence that is at least 90% or at least 95% identical to the amino acid sequence of SEQ ID NO: 6, and which has the endolysin activity of the endolysin of SEQ ID NO: 6. In various embodiments, the endolysin used in the present invention comprises a polypeptide having an amino acid sequence that is at least 96% or at least 97% identical to the amino acid sequence of SEQ ID NO: 6, and which has the endolysin activity of the endolysin of SEQ ID NO: 6. In various other embodiments, the endolysin used in the present invention comprises a polypeptide having an amino acid sequence that is at least 98% or at least 99% identical to the amino acid sequence of SEQ ID NO: 6, and which has the endolysin activity of the endolysin of SEQ ID NO: 6.

In a preferred embodiment the endolysin used in the present invention is encoded by a nucleic acid molecule comprising a polynucleotide having the nucleotide sequence of SEQ ID NO: 5.

Further encompassed by the present invention is an endolysin, which is encoded by a nucleic acid molecule, which comprises a polynucleotide that is at least 80% or at least 85% identical to the nucleotide sequence of SEQ ID NO: 5, and that encodes a polypeptide having the endolysin activity of the endolysin of SEQ ID NO: 6. Still further encompassed by the present invention is an endolysin, which is encoded by a nucleic acid molecule, which comprises a polynucleotide that is at least 90% or at least 95% identical to the nucleotide sequence of SEQ ID NO: 5, and that encodes a polypeptide having the endolysin activity of the endolysin of SEQ ID NO: 6. In various embodiments, the endolysin used in the present invention is an endolysin, which is encoded by a nucleic acid molecule, which comprises a polynucleotide that is at least 96% or at least 97% identical to the nucleotide sequence of SEQ ID NO: 5, and that encodes a polypeptide having the endolysin activity of the endolysin of SEQ ID NO: 6. In various other embodiments, the endolysin used in the present invention is an endolysin, which is encoded by a nucleic acid molecule, which comprises a polynucleotide that is at least 98% or at least 99% identical to the nucleotide sequence of SEQ ID NO: 5, and that encodes a polypeptide having the endolysin activity of the endolysin of SEQ ID NO: 6.

In various embodiments, the endolysin used in the present invention is a variant of endolysin gu3-825, which comprises a CBD, which comprises a polypeptide having an amino acid sequence that is at least 80% or at least 85% identical to the sequence of amino acid residues 237 to 400 of SEQ ID NO: 6, and a first EAD, which comprises a polypeptide having an amino acid sequence that is at least 80% or at least 85% identical to the sequence of amino acid residues 1 to 236 of SEQ ID NO: 6, and a second EAD, which comprises a polypeptide having an amino acid sequence that is at least 80% or at least 85% identical to the sequence of amino acid residues 401 to 547 of SEQ ID NO: 6, wherein said variant gu3-825 endolysin exhibits the same endolysin activity as the endolysin of SEQ ID NO: 6. In various embodiments, the endolysin used in the present invention is a variant of endolysin gu3-825, which comprises a CBD, which comprises a polypeptide having an amino acid sequence that is at least 90% or at least 95% identical to the sequence of amino acid residues 237 to 400 of SEQ ID NO: 6, and a first EAD, which comprises a polypeptide having an amino acid sequence that is at least 90% or at least 95% identical to the sequence of amino acid residues 1 to 236 of SEQ ID NO: 6, and a second EAD, which comprises a polypeptide having an amino acid sequence that is at least 90% or at least 95% identical to the sequence of amino acid residues 401 to 547 of SEQ ID NO: 6, wherein said variant gu3-825 endolysin exhibits the same endolysin activity as the endolysin of SEQ ID NO: 6. In various further embodiments, the endolysin used in the present invention is a variant of endolysin gu3-825, which comprises a CBD, which comprises a polypeptide having an amino acid sequence that is at least 96% or at least 97% identical to the sequence of amino acid residues 237 to 400 of SEQ ID NO: 6, and a first EAD, which comprises a polypeptide having an amino acid sequence that is at least 96% or at least 97% identical to the sequence of amino acid residues 1 to 236 of SEQ ID NO: 6, and a second EAD, which comprises a polypeptide having an amino acid sequence that is at least 96% or at least 97% identical to the sequence of amino acid residues 401 to 547 of SEQ ID NO: 6, wherein said variant gu3-825 endolysin exhibits the same endolysin activity as the endolysin of SEQ ID NO: 6. In various other embodiments, the endolysin used in the present invention is a variant of endolysin gu3-825, which comprises a CBD, which comprises a polypeptide having an amino acid sequence that is at least 98% or at least 99% identical to the sequence of amino acid residues 237 to 400 of SEQ ID NO: 6, and a first EAD, which comprises a polypeptide having an amino acid sequence that is at least 98% or at least 99% identical to the sequence of amino acid residues 1 to 236 of SEQ ID NO: 6, and a second EAD, which comprises a polypeptide having an amino acid sequence that is at least 98% or at least 99% identical to the sequence of amino acid residues 401 to 547 of SEQ ID NO: 6, wherein said variant gu3-825 endolysin exhibits the same endolysin activity as the endolysin of SEQ ID NO: 6.

In various embodiments, the endolysin used in the present invention is a variant of endolysin gu3-825, which comprises the CBD of gu3-825 (i.e., amino acid residues 237 to 400 of SEQ ID NO: 6), a first EAD, which comprises a polypeptide having an amino acid sequence that is at least 80% or at least 85% identical to the sequence of amino acid residues 1 to 236 of SEQ ID NO: 6, and a second EAD, which comprises a polypeptide having an amino acid sequence that is at least 80% or at least 85% identical to the sequence of amino acid residues 401 to 547 of SEQ ID NO: 6, wherein said variant gu3-825 endolysin exhibits the same endolysin activity as the endolysin of SEQ ID NO: 6. In various embodiments, the endolysin used in the present invention is a variant of endolysin gu3-825, which comprises the CBD of gu3-825 (i.e., amino acid residues 237 to 400 of SEQ ID NO: 6), a first EAD, which comprises a polypeptide having an amino acid sequence that is at least 90% or at least 95% identical to the sequence of amino acid residues 1 to 236 of SEQ ID NO: 6, and a second EAD, which comprises a polypeptide having an amino acid sequence that is at least 90% or at least 95% identical to the sequence of amino acid residues 401 to 547 of SEQ ID NO: 6, wherein said variant gu3-825 endolysin exhibits the same endolysin activity as the endolysin of SEQ ID NO: 6. In various further embodiments, the endolysin used in the present invention is a variant of endolysin gu3-825, which comprises the CBD of gu3-825 (i.e., amino acid residues 237 to 400 of SEQ ID NO: 6), a first EAD, which comprises a polypeptide having an amino acid sequence that is at least 96% or at least 97% identical to the sequence of amino acid residues 1 to 236 of SEQ ID NO: 6, and a second EAD, which comprises a polypeptide having an amino acid sequence that is at least 96% or at least 97% identical to the sequence of amino acid residues 401 to 547 of SEQ ID NO: 6, wherein said variant gu3-825 endolysin exhibits the same endolysin activity as the endolysin of SEQ ID NO: 6. In various other embodiments, the endolysin used in the present invention is a variant of endolysin gu3-825, which comprises the CBD of gu3-825 (i.e., amino acid residues 237 to 400 of SEQ ID NO: 6), a first EAD, which comprises a polypeptide having an amino acid sequence that is at least 98% or at least 99% identical to the sequence of amino acid residues 1 to 236 of SEQ ID NO: 6, and a second EAD, which comprises a polypeptide having an amino acid sequence that is at least 98% or at least 99% identical to the sequence of amino acid residues 401 to 547 of SEQ ID NO: 6, wherein said variant gu3-825 endolysin exhibits the same endolysin activity as the endolysin of SEQ ID NO: 6.

In various embodiments, the endolysin used in the present invention is a variant of endolysin gu3-825, which comprises the CBD of gu3-825 (i.e., amino acid residues 237 to 400 of SEQ ID NO: 6), the second EAD of gu3-825 (i.e., amino acid residues 401 to 547 of SEQ ID NO: 6), and a first EAD, which comprises a polypeptide having an amino acid sequence that is at least 80% or at least 85% identical to the sequence of amino acid residues 1 to 236 of SEQ ID NO: 6, wherein said gu3-825 variant endolysin exhibits the same endolysin activity as the endolysin of SEQ ID NO: 6 and has a pH optimum below pH 6 with respect to its lytic activity. In various embodiments, the endolysin used in the present invention is a variant of endolysin gu3-825, which comprises the CBD of gu3-825 (i.e., amino acid residues 237 to 400 of SEQ ID NO: 6), the second EAD of gu3-825 (i.e., amino acid residues 401 to 547 of SEQ ID NO: 6), and a first EAD, which comprises a polypeptide having an amino acid sequence that is at least 90% or at least 95% identical to the sequence of amino acid residues 1 to 236 of SEQ ID NO: 6, wherein said gu3-825 variant endolysin exhibits the same endolysin activity as the endolysin of SEQ ID NO: 6. In various further embodiments, the endolysin used in the present invention is a variant of endolysin gu3-825, which comprises the CBD of gu3-825 (i.e., amino acid residues 237 to 400 of SEQ ID NO: 6), the second EAD of gu3-825 (i.e., amino acid residues 401 to 547 of SEQ ID NO: 6), and a first EAD, which comprises a polypeptide having an amino acid sequence that is at least 96% or at least 97% identical to the sequence of amino acid residues 1 to 236 of SEQ ID NO: 6, wherein said gu3-825 variant endolysin exhibits the same endolysin activity as the endolysin of SEQ ID NO: 6. In various embodiments, the endolysin used in the present invention is a variant of endolysin gu3-825, which comprises the CBD of gu3-825 (i.e., amino acid residues 237 to 400 of SEQ ID NO: 6), the second EAD of gu3-825 (i.e., amino acid residues 401 to 547 of SEQ ID NO: 6), and a first EAD, which comprises a polypeptide having an amino acid sequence that is at least 98% or at least 99% identical to the sequence of amino acid residues 1 to 236 of SEQ ID NO: 6, wherein said gu3-825 variant endolysin exhibits the same endolysin activity as the endolysin of SEQ ID NO: 6.

In general, gu3-825 endolysins of the present invention, including gu3-825 endolysin variants described herein, have a pH-optimum below pH 6 with respect to its lytic activity. In various embodiments, gu3-825 endolysins of the present invention, including gu3-825 endolysin variants thereof described herein, have a pH-optimum in the range of about 3.0 to about 6.0, preferably in the range of about 3.9 to about 5.9, more preferably in the range of about 4.0 to about 5.7, even more preferably in the range of about 4.2 to about 5.6, most preferably in the range of about 4.5 to about 5.5. In various embodiments, gu3-825 endolysins of the present invention, including gu3-825 endolysin variants described herein, have a pH-optimum of about 5.5 or below with respect to its lytic activity. In various embodiments, gu3-825 endolysins of the present invention, including gu3-825 endolysin variants described herein, have a pH-optimum of about 5.2 or below, or of about 5.1 or below, with respect to its lytic activity.

General Aspects of the Methods of the Present Invention

A Listeria bacteriophage endolysin to be used/applied in the present invention is effective to inhibit growth of Listeria bacteria in a pasta filata cheese or a pasta filata cheese food product.

In the present invention, a Listeria bacteriophage endolysin may be applied to the pasta filata cheese or pasta filata cheese food product by a number of means, including, but not limited to, admixing the endolysin into the cheese or cheese food product, or spraying the endolysin onto the cheese or cheese food product or adding the endolysin to the brine bath. Said applications significantly reduce the numbers of Listeria bacteria.

The concentration of a Listeria bacteriophage endolysin for administration in the methods of the present invention and for administration on or into cheese or cheese food products of the present invention can be determined by the one of skill in the art. That is, a suitable concentration is, for example, a concentration that provides for effectively controlling Listeria contamination in cheese according to the present invention. In various embodiments, the concentration is contemplated to be in the range of about 0.1-100 μg/ml, including the range of about 1-10 μg/ml and 0.5-5 μg/ml. In various embodiments, the concentration is contemplated to be in the range of about 1-5 μg/ml, 5-10 μg/ml, or 10-20 μg/ml. In various other embodiments, the concentration is contemplated to be in the range of about 20-40 μg/ml, 40-60 μg/ml, 60-80 μg/ml, or 80-100 μg/ml.

In the present invention, the Listeria bacteriophage endolysin can be used/applied in a liquid or a powdered form to the pasta filata cheese or pasta filata cheese food product according to the present invention. In various embodiments, the Listeria bacteriophage endolysin is used/applied as part of a solution or a composition comprising the endolysin. The skilled person can determine suitable formulations of a solution or composition containing a Listeria bacteriophage endolysin for being used/applied in the methods and food products according to the present invention.

In various embodiments the endolysin is administered until a successful reduction of the Listeria contamination is achieved or until the amount of Listeria bacteria is substantially reduced in pasta filata cheese or a pasta filata cheese food product according to the present invention.

In various embodiments, the Listeria bacteriophage endolysin is recombinantly produced.

The methods for controlling Listeria contamination and for extending the shelf life of a pasta filata cheese or a pasta filata cheese food product according to the present invention are not limited to the application of one single Listeria bacteriophage endolysin. That is, the methods for controlling Listeria contamination and for extending the shelf life of a pasta filata cheese or a pasta filata cheese food product according to the present invention include applying one or more Listeria bacteriophage endolysins.

In various embodiments, the Listeria bacteriophage endolysin is effective to limit growth of Listeria bacteria in the pasta filata cheese or pasta filata cheese food product according to the present invention to less than 3 logs, preferably 2 logs, more preferably 1 log over at least about 30 days of storage of a pasta filata cheese or pasta filata cheese food product as described herein.

In various embodiments, the Listeria bacteriophage endolysin is effective to limit growth of Listeria bacteria in the pasta filata cheese or pasta filata cheese food product according to the present invention to less than 3 logs, preferably 2 logs, more preferably 1 log over at least about 15 days of storage of a pasta filata cheese or pasta filata cheese food product as described herein.

In the present invention, “Listeria contamination” means “undesired Listeria contamination”. Furthermore, in the present invention undesired Listeria contamination includes, but is not limited to, contamination of pathogenic Listeria bacteria. Here, pathogenic means exhibiting pathogenicity to human beings and/or animals. Listeria monocytogenes is pathogenic to both human and animals. Therefore, in the present invention controlling Listeria contamination preferably is controlling Listeria monocytogenes contamination. Likewise, in the present invention extending the shelf life of pasta filata cheese or a pasta filata cheese food product is due to controlling Listeria monocytogenes contamination according to the present invention.

In various embodiments, controlling Listeria contamination according to the present invention means that after applying an endolysin encompassed by the present invention to a pasta filata cheese or a pasta filata cheese food product contaminated with Listeria the number of Listeria bacteria is reduced compared to the number of Listeria bacteria prior to applying the endolysin according to the present invention.

Further Definitions

In the present invention, “Percentage (%) of sequence identity” is determined by comparing two optimally aligned sequences over a comparison window, wherein the portion of the polynucleotide sequence in the comparison window may comprise additions or deletions (i.e., gaps) as compared to the reference sequence (which does not comprise additions or deletions) for optimal alignment of the two sequences. The percentage is calculated by determining the number of positions at which the identical nucleic acid base or amino acid residue occurs in both sequences to yield the number of matched positions, dividing the number of matched positions by the total number of positions in the window of comparison and multiplying the result by 100 to yield the percentage of sequence identity.

The terms “identical” or percent “identity”, in the context of two or more nucleic acids or polypeptide sequences, refer to two or more sequences or sub-sequences that are the same or have a specified percentage of amino acid resides or nucleotides that are the same, when compared and aligned for maximum correspondence over a comparison window, or designated region as measured using one of the following sequence comparison algorithms or by manual alignment and visual inspection. Such sequences are then said to be “substantially identical”. This definition also refers to the complement of a test sequence. Optionally, the identity exists over a region that is at least about 50 amino acids or nucleotides in length, or more preferably over a region that is 75-100 amino acids or nucleotides in length.

For sequence comparison, typically one sequence acts as a reference sequence, to which test sequences are compared. When using a sequence comparison algorithm, test and reference sequences are entered into a computer, subsequence coordinates are designated, if necessary, and sequence algorithm program parameters are designated. Default program parameters can be used, or alternative parameters can be designated. The sequence comparison algorithm then calculates the percent sequence identities for the test sequences relative to the reference sequence, based on the program parameters.

The terms nucleic acid molecule and nucleic acid sequence may be used herein interchangeably.

As discussed herein, the present invention encompasses the use of variants and derivatives of endolysins encompassed by the present invention. Such protein variants and derivatives are well understood to those of skill in the art and in can involve amino acid sequence modifications. For example, amino acid sequence modifications typically fall into one or more of three classes: substitutional, insertional or deletional variants. Insertions include amino and/or carboxyl terminal fusions as well as intrasequence insertions of single or multiple amino acid residues. Deletions are characterized by the removal of one or more amino acid residues from the protein sequence. Typically, no more than about from 2 to 6 residues are deleted at any one site within protein molecules according to the present invention. These variants ordinarily are prepared by site specific mutagenesis of nucleotides in the DNA encoding the protein, thereby producing DNA encoding the variant, and thereafter expressing the DNA in recombinant cell culture. Techniques for making substitution mutations at predetermined sites in DNA having a known sequence are well known to the ones skilled in the art. Amino acid substitutions are typically of single residues, but can occur at a number of different locations at once; insertions usually will be on the order of about from 1 to 10 amino acid residues; and deletions will range about from 1 to 30 residues. Deletions or insertions preferably are made in adjacent pairs, i.e. a deletion of 2 residues or insertion of 2 residues. Substitutions, deletions, insertions or any combination thereof may be combined to arrive at a final construct. The mutations must not place the sequence out of reading frame and preferably will not create complementary regions that could produce secondary mRNA structure. Substitutional variants are those in which at least one amino acid residue has been removed and a different amino acid residue inserted in its place such that a conservative substitution is obtained. The meaning of a conservative substitution is well known to the person skilled in the art.

Certain post-translational modifications are the result of the action of recombinant host cells on the expressed polypeptide. Glutaminyl and asparaginyl residues are frequently post-translationally deamidated to the corresponding glutamyl and asparyl residues. Alternatively, these residues are deamidated under mildly acidic conditions. Other post-translational modifications include hydroxylation of proline and lysine, phosphorylation of hydroxyl groups of seryl or threonyl residues, methylation of the o-amino groups of lysine, arginine, and histidine side chains, acetylation of the N-terminal amine and, in some instances, amidation of the C-terminal carboxyl. Such post-translational modifications are also contemplated by the present invention.

As pasta filata cheese is food, the terms “pasta filata cheese food product” and “pasta filata cheese product” may be used herein interchangeably. Furthermore, the terms “pasta filata cheese” and “pasta filata cheese food” may be used herein interchangeably.

In the present invention, the terms “growth in a pasta filata cheese or a pasta filata cheese food product” and “growth on a pasta filata cheese or a pasta filata cheese food product” may be used interchangeably.

As used herein, the term “Listeria” means the bacterial genus Listeria. In the present invention, the genus Listeria encompasses all known Listeria species. In particular, in the present invention the genus Listeria includes, but is not limited to, the following Listeria species: L. monocytogenes, L. seeligeri, L. ivanovii, L. innocua, L. welshimeri, L. grayi ssp. grayi, and L. grayi ssp. murrayi. In the present invention, the preferred Listeria species is a Listeria species that is pathogenic to human beings and/or animals.

In various embodiments of the present invention, the preferred Listeria species is Listeria monocytogenes, which is pathogen to both human and animals. In the present invention, Listeria serovars 1/2, 3, and 4 include, but are not limited to, Listeria monocytogenes serovars 1/2, 3, and 4, respectively.

In various embodiments, the preferred Listeria monocytogenes serovar is serovar 1/2. In various other embodiments, the preferred Listeria monocytogenes serovar is serovar 3. In various further embodiments, the preferred Listeria monocytogenes serovar is serovar 4.

In the present invention Listeria monocytogenes includes serotypes 1/2a, 1/2b, 1/2c, 3a, 3b, 3c, 4a, 4ab, 4b, 4c, 4d, 4e, and 7. In various embodiments, the Listeria species is selected from the group consisting of L. monocytogenes serotype 1/2a, L. monocytogenes serotype 1/2b, L. monocytogenes serotype 1/2c, L. monocytogenes serotype 3a, L. monocytogenes serotype 3, L. monocytogenes serotype 3c, L. monocytogenes serotype 4a, L. monocytogenes serotype 4ab, L. monocytogenes serotype 4b, L. monocytogenes serotype 4c, L. monocytogenes serotype 4d, L. monocytogenes serotype 4e, and L. monocytogenes serotype 7.

In more preferred embodiments of the present invention the Listeria species is selected from the group consisting of L. monocytogenes 1142 serovar 1/2a, L. monocytogenes 1042 serovar 4b, L. monocytogenes 1019 serovar 4c, L. monocytogenes 1001 serovar 1/2c, L. monocytogenes EGDe serovar 1/2a, L. monocytogenes SLCC 7150 serovar 1/2a, L. monocytogenes SLCC 7154 serovar 1/2c, L. monocytogenes SLCC 7290 serovar 1/2c, L. monocytogenes 0756062 serovar 1/2c, L. monocytogenes WSLC1485 serovar 1/3a, L. monocytogenes WSLC 11082 serovar 1/3c, L. monocytogenes WSLC 11083 serovar 1/3c, L. monocytogenes ScottA serovar 4b, L. monocytogenes WSLC 1048 serovar 4d, L. monocytogenes 8309032 serovar 4d, and L. monocytogenes 8309033 serovar 4e.

In various embodiments, the preferred Listeria species is Listeria ivanovii, which is pathogenic to animals. In preferred embodiments, the Listeria species is Listeria ivanovii serotype 5.

The literature discloses reports about diseases in human beings resulting from infection with Listeria seeligeri (Rocourt et al. 1987) and L. ivanovii (Cummins et al. 1994). In the present invention Listeria seeligeri includes serotypes I/2a, I/2b, I/2c, 4b, 4c, 4d, and 6b. In various embodiments, the Listeria species is selected from the group consisting of L. seeligeri serotype I/2a, serotype I/2b, serotype I/2c, serotype 4b, serotype 4c, serotype 4d, and serotype 6b.

In the present invention Listeria innocua includes serotypes 3, 6a, 6b, 4ab, and U/S. In various embodiments, the Listeria species is selected from the group consisting of L. innocua serotype 3, L. innocua serotype 6a, L. innocua serotype 6b, L. innocua serotype 4ab, and L. innocua serotype U/S. Preferably, L. innocua is L. innocua 2011 serotype 6a.

In the present invention Listeria welshimeri includes serotypes 1/2a, 4c, 6a, 6b, and U/S. In various embodiments, the Listeria species is selected from the group consisting of L. welshimeri serotype 1/2a, L. welshimeri serotype 4c, L. welshimeri serotype 6a, L. welshimeri serotype 6b, and L. welshimeri serotype U/S.

In the present invention Listeria grayi includes serotype Grayi. In various embodiments, the Listeria species is L. grayi serotype Grayi.

In the present invention, the terms “serotype” and “serovar” may be used interchangeably.

In the present invention, the terms “controlling Listeria contamination” and “controlling undesired Listeria colonization” may be used interchangeably.

The term “domain” or “protein domain”, as used herein, denotes a portion of an amino acid sequence that either has a specific functional and/or structural property. On the basis of amino acid sequence homologies, domains can frequently be predicted by employing appropriate computer programs that compare the amino acid sequences in freely available databases with known domains, e.g., Conserved Domain Database (CDD) at the NCBI (Marchler-Bauer et al., 2005, Nucleic Acids Res. 33, D192-6), Pfam (Finn et al., 2006, Nucleic Acids Research 34, D247-D251), or SMART (Schultz et al., 1998, Proc. Natl. Acad. Sci. USA 95, 5857-5864, Letunic et al., 2006, Nucleic Acids Res 34, D257-D260).

Whenever reference is made to the lytic activity of the polypeptide of SEQ ID NO: 2 (PlyP40), the endolysin activity of PlyP40 is meant. Specifically, the endolysin activity of the polypeptide of SEQ ID NO: 2 (PlyP40) is the lytic activity of the polypeptide of SEQ ID NO: 2 (PlyP40) against Listeria bacterial cells described herein, preferably against pathogenic Listeria bacterial cells, more preferably against Listeria monocytogenes. In general, the enzymatic activity of the endolysin of SEQ ID NO: 2 comprises the enzymatic activity as described for PlyP40 in WO 2010/010192 (PCT/EP2009/059606). More specifically, the lytic activity of the endolysin PlyP40 is hydrolytic activity, still more specifically hydrolytic activity against peptidoglycan in the cell wall of Listeria bacterial cells. Therefore, the lytic activity of the endolysin PlyP40 may also be described as peptidoglycan hydrolase activity or peptidoglycan hydrolytic activity.

The EAD of endolysin PlyP40 has lytic activity against Listeria bacterial cells. In various embodiments of the present invention, the lytic activity of the EAD of PlyP40 against Listeria bacterial cells is peptidoglycan hydrolase activity, i.e. hydrolytic activity against peptidoglycan in the cell wall of Listeria bacterial cells. The peptidoglycan hydrolase activity of the EAD of PlyP40 may also be called peptidoglycan-digesting activity or muralytic activity. In various embodiments, the lytic activity of the EAD of PlyP40 is muramidase activity or N-Acteyl-glucosaminidase activity. In various embodiments, the lytic activity of the EAD of PlyP40 is amidase activity or endopeptidase activity. Preferably, the lytic activity of the EAD of PlyP40 is peptidoglycan amidase activity. More preferably, the lytic activity of the EAD of PlyP40 is L-muramoyl-L-alanine amidase activity, D-alanyl-glycyl endopeptidase activity, or D-6-meso-DAP-peptidase or meso-DAP-D-Ala peptidase activity. In various embodiments, the lytic activity of the EAD of PlyP40 is peptidoglycan transglycosylase activity. More preferably, the lytic activity of the EAD of PlyP40 is murein transglycosylase activity. In various embodiments, the lytic activity of the EAD of PlyP40 is peptidase activity, preferably carboxypeptidase activity. In various embodiments, the lytic activity of the EAD of PlyP40 is glycosyl hydrolase activity. In various embodiments, the lytic activity of the EAD of PlyP40 is N-acetylmuramoyl-L-alanine amidase activity. In various embodiments, the lytic activity of the EAD of PlyP40 is cysteine histidine-dependent amidohydrolase/peptidase activity.

As described herein, the CBD of PlyP40 has cell wall binding activity. This cell wall binding activity provides for targeting the lysin to its substrate, namely the peptidoglycan of Listeria bacterial cells. Therefore, in particular the cell wall binding activity of the CBD of PlyP40 is Listeria cell wall binding activity. It is clear to the skilled person that CBDs according to the present invention have no or no significant hydrolytic activity like the EADs, i.e. CBDs according to the present invention have no or no significant hydrolytic activity against Listeria bacterial cell walls. Here, no or no significant hydrolytic activity is intended to describe the situation whereby the hydrolytic activity of a CBD of the present invention is not sufficient to prevent the application of such a CBD to bind to the cell wall of a Listeria bacterial cell. A CBD according to the present invention is supposed to be a protein, which has no or no significant hydrolytic activity itself.

In various embodiments, the cell wall binding activity of the CBD of PlyP40 is binding to peptidoglycan of the cell wall of Listeria bacterial cells. Preferably, the cell wall binding activity of the CBD of PlyP40 is binding to a carbohydrate or cholin moiety in the cell wall of Listeria bacterial cells. More preferably, the cell wall binding activity of the CBD of PlyP40 is binding to a carbohydrate of the peptidoglycan or teichoic acid or lipoteichoic acid in the cell wall of Listeria bacterial cells.

Whenever reference is made to the lytic activity of the polypeptide of SEQ ID NO: 6 (gu3-825), the endolysin activity of gu3-825 is meant. Specifically, the endolysin activity of the polypeptide of SEQ ID NO: 6 (gu3-825) is the lytic activity of the polypeptide of SEQ ID NO: 6 (gu3-825) against Listeria bacterial cells described herein, preferably against pathogenic Listeria bacterial cells, more preferably against Listeria monocytogenes. More specifically, the lytic activity of the endolysin gu3-825 is hydrolytic activity, still more specifically hydrolytic activity against peptidoglycan in the cell wall of Listeria bacterial cells. Therefore, the lytic activity of the endolysin gu3-825 may also be described as peptidoglycan hydrolase activity or peptidoglycan hydrolytic activity.

The EADs of endolysin gu3-825 has lytic activity against Listeria bacterial cells. In various embodiments of the present invention, the lytic activity of the EADs of gu3-825 against Listeria bacterial cells is peptidoglycan hydrolase activity, i.e. hydrolytic activity against peptidoglycan in the cell wall of Listeria bacterial cells. The peptidoglycan hydrolase activity of the EADs of gu3-825 may also be called peptidoglycan-digesting activity or muralytic activity. In various embodiments, the lytic activity of the EADs of gu3-825 is muramidase activity or N-Acteyl-glucosaminidase activity. In various embodiments, the lytic activity of the EADs of gu3-825 is amidase activity or endopeptidase activity. Preferably, the lytic activity of the EADs of gu3-825 is peptidoglycan amidase activity. More preferably, the lytic activity of the EADs of gu3-825 is L-muramoyl-L-alanine amidase activity, D-alanyl-glycyl endopeptidase activity, or D-6-meso-DAP-peptidase or meso-DAP-D-Ala peptidase activity. In various embodiments, the lytic activity of the EADs of gu3-825 is peptidoglycan transglycosylase activity. More preferably, the lytic activity of the EADs of gu3-825 is murein transglycosylase activity. In various embodiments, the lytic activity of the EADs of gu3-825 is peptidase activity, preferably carboxypeptidase activity. In various embodiments, the lytic activity of the EADs of gu3-825 is glycosyl hydrolase activity. In various embodiments, the lytic activity of the EADs of gu3-825 is N-acetylmuramoyl-L-alanine amidase activity. In various embodiments, the lytic activity of the EADs of gu3-825 is cysteine histidine-dependent amidohydrolase/peptidase activity.

As described herein, the CBD of gu3-825 has cell wall binding activity. This cell wall binding activity provides for targeting the lysin to its substrate, namely the peptidoglycan of Listeria bacterial cells. Therefore, in particular the cell wall binding activity of the CBD of gu3-825 is Listeria cell wall binding activity. It is clear to the skilled person that CBDs according to the present invention have no or no significant hydrolytic activity like the EADs, i.e. CBDs according to the present invention have no or no significant hydrolytic activity against Listeria bacterial cell walls. Here, no or no significant hydrolytic activity is intended to describe the situation whereby the hydrolytic activity of a CBD of the present invention is not sufficient to prevent the application of such a CBD to bind to the cell wall of a Listeria bacterial cell. A CBD according to the present invention is supposed to be a protein, which has no or no significant hydrolytic activity itself.

In various embodiments, the cell wall binding activity of the CBD of gu3-825 is binding to peptidoglycan of the cell wall of Listeria bacterial cells. Preferably, the cell wall binding activity of the CBD of gu3-825 is binding to a carbohydrate or cholin moiety in the cell wall of Listeria bacterial cells. More preferably, the cell wall binding activity of the CBD of gu3-825 is binding to a carbohydrate of the peptidoglycan or teichoic acid or lipoteichoic acid in the cell wall of Listeria bacterial cells.

The terms “protein” and “polypeptide” are used in the present invention interchangeably. In the present invention, the term “endolysin” describes a protein or polypeptide. Accordingly, the terms “endolysin(s)”, “endolysin protein(s)” and “endolysin polypeptide(s)” may be used herein interchangeably.

Furthermore, the term “sv” represent the well known abbreviation of the term “serovar”.

When particular embodiments of the invention are described herein, the corresponding paragraphs/text passages of the description invariably make reference to means and/or methods described elsewhere in the description. In this context, terms like “according to the present invention”, “of the present invention” and “provided by the present invention” are used. That is, when a particular embodiment of the invention is described in a certain paragraph or text passage, reference is made to means and/or methods “according to the present invention” or “of the present invention”, which are described elsewhere in the description. For a particular embodiment described, such references are intended to incorporate for the particular embodiment all means and/or methods, which are described elsewhere in the description and which are provided by the present invention and therefore form part of the scope of the invention. For example, if the description of a particular embodiment refers to “a pasta filata cheese or a pasta filata cheese food product provided by the present invention” or “a pasta filata cheese or a pasta filata cheese food product according to the present invention”, it is intended that all pasta filata cheeses and pasta filata cheese food products, which are described elsewhere in the description, and which are provided by the present invention and therefore form part of the scope of the invention, are applicable to the particular embodiment. This also particularly applies, for example, to fragments and variants of endolysins encompassed by the present invention, which are defined in the present invention and which are applicable to the various embodiments described throughout the application text.

The above principle applies to all embodiments making use of terms like “according to the present invention”, “of the present invention” and “provided by the present invention”. It goes without saying that not each embodiment described herein can specifically mention the means and/or methods of the invention, which are already defined elsewhere in the description, and which are applicable to the various embodiments described throughout the application text. Otherwise, each patent application would comprise several hundreds of description pages.

Furthermore, terms like “in various embodiments” and “in various other/further embodiments” mean “in various embodiments of the present invention” and “in various other/further embodiments of the present invention”.

The invention is exemplified by the examples, which are not considered to limit the scope of the present invention.

### EXAMPLES

### Example 1

### Treatment of Mozzarella Cheese with Endolysin PlyP40

The inhibiting effect on growth of Listeria monocytogenes on mozzarella cheese is shown after treatment with the endolysin PlyP40 (SEQ ID NO: 2).

Slices of Mozzarella cheese of 2 cm×5 cm×1 cm were prepared. 100 μl of an aqueous preparation of endolysin PlyP40 (100 μg/ml) was applied on the surface of the mozzarella slices. As a control, 100 μl water was applied on the surface of mozzarella slices. Next, 10 μl of Listeria monocytogenes inoculum comprising 1.5×10⁵ cfu or 3.7×10² cfu was applied on the slices. The applied liquids were spread evenly over the surface of the mozzarella cheese slices and the slices were incubated for 0, 24 or 48 hours at 15° C. After incubation, each of the slices was washed in 20 ml of an aqueous solution comprising 0.1% w/w peptone. Next, serial dilutions of the obtained washing solutions were made (dilution factor: 20 times, 100, times, 1000 times, 10,000 times, 100,000 times) and 1 ml of the diluted washing solutions was applied onto selective Modified Oxford Medium (MOX) agar plates with Antimicrobic Supplement using the pour plate method. The plates were incubated for 48 hours at 35° C.

Colonies of Listeria on MOX typically appear as black indentations and often turn the surrounding agar black due to esculin-hydrolyzation. Colonies exhibiting these characteristic colony morphologies and biochemical reactions were counted.

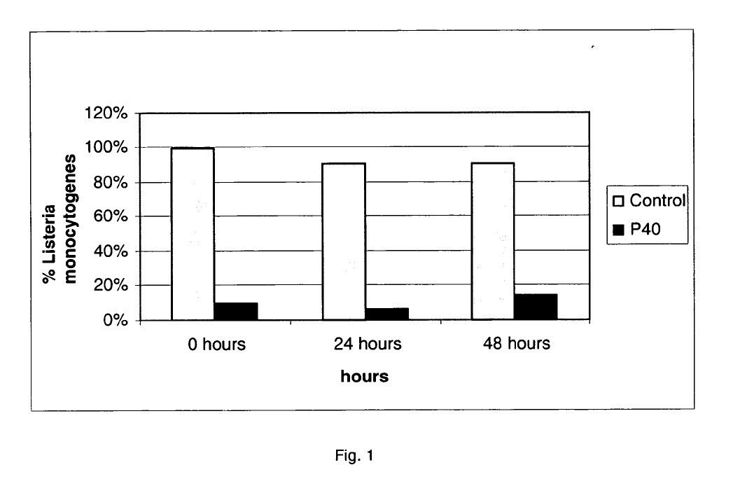

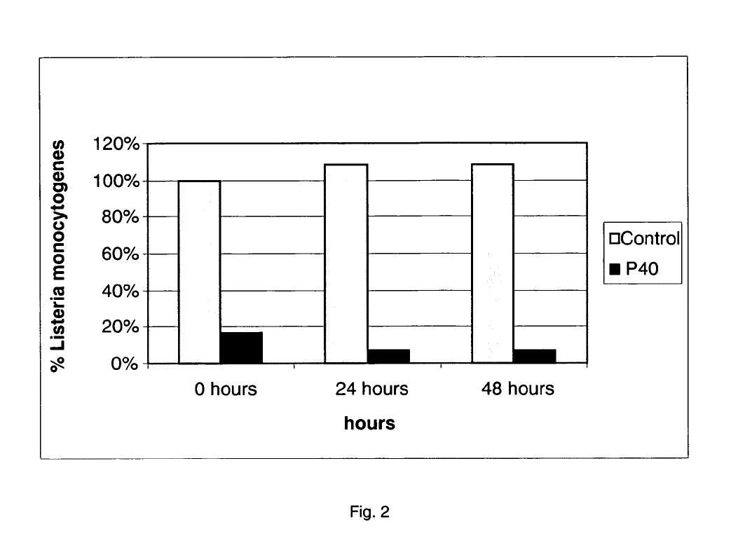

Calculations on the lysis of Listeria were based on dilutions leading to around 100 colonies per plate and when only lower numbers were present on plates with the lowest diluted sample (i.e., 20 times dilution factor), these numbers were used. The results are shown in FIGS. 1 and 2. The results clearly show that an endolysin having a pH optimum of 6 or below can be used to control Listeria contamination of a pasta filata cheese.

### Example 2

### Treatment of Mozzarella Cheese with Endolysins Having Different pH Optimum

The inhibiting effect on growth of Listeria monocytogenes on mozzarella cheese is shown after treatment with endolysins having a different pH optimum. The endolysins tested were PlyP40, PlyP825 (see SEQ ID NO: 3 and 4 for nucleotide and amino acid sequence of PlyP825) and Ply511 (see WO 96/07756).

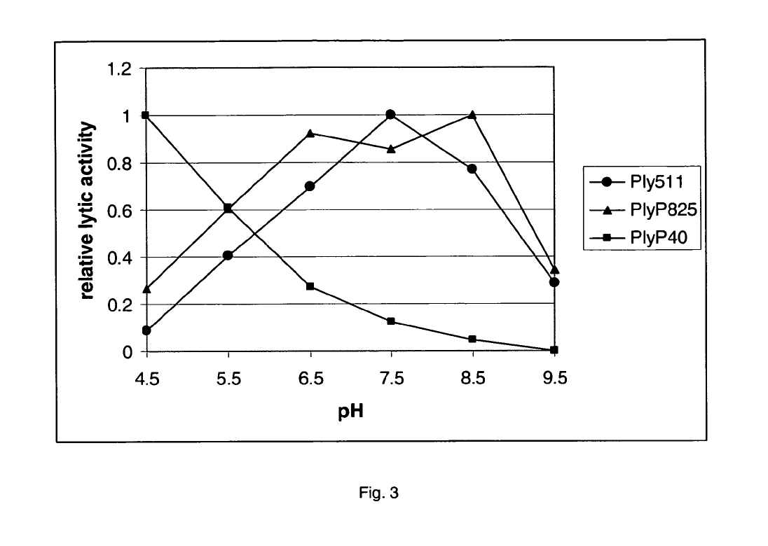

The pH optimum for the lytic activity of the above endolysins was measured as follows. The results are shown in FIG. 3. The lytic activity as a function of the pH was determined applying photometric lysis tests. In particular, heat-inactivated cells of Listeria monocytogenes EGDe (sv 1/2a; ProCC S1095) were suspended in buffer (50 mM sodium citrate, 50 mM NaH₂PO₄, 50 mM borate and 100 mM NaCl), which was adjusted to pH values of 4.5, 5.5, 6.5, 7.5, 8.5 and 9.5, respectively. As shown in FIG. 3, PlyP825 and Ply511 exhibit optimum (i.e. highest) lytic activity at a pH above 6 (i.e. pH optimum for PlyP825 is 7-9 and pH optimum for Ply511 is 7.5-8). The result also show that PlyP40 exhibits optimum (i.e. highest) lytic activity at pH of 6 or below (i.e. pH optimum for PlyP40 is 4.5).

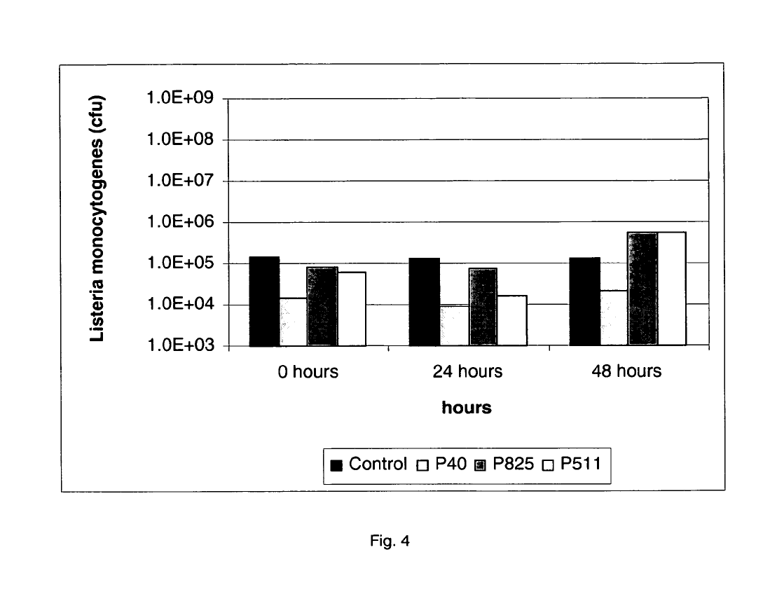

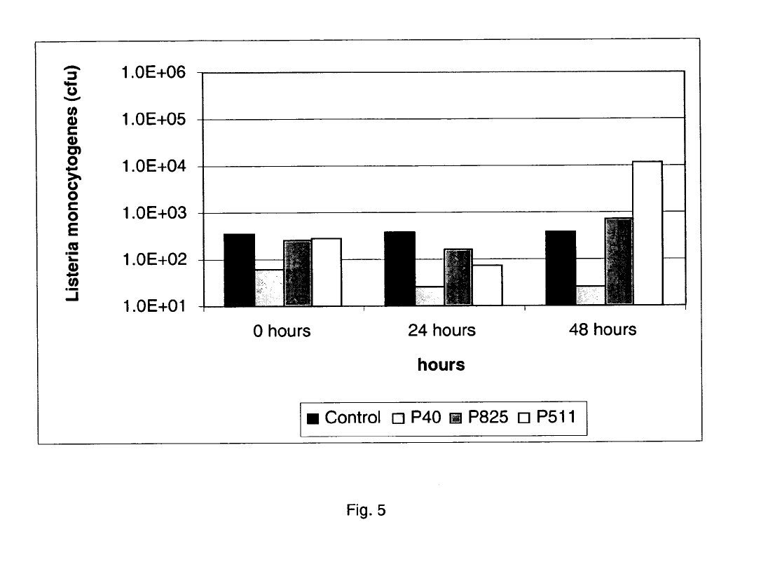

The experiment showing inhibiting effect on growth of Listeria monocytogenes on mozzarella cheese after treatment with PlyP40, PlyP825 and Ply511 was done as described in Example 1. As a control water was used. The results are shown in FIGS. 4 and 5. The results clearly show that an endolysin having optimum lytic activity at a pH of 6 or below (e.g. PlyP40) strongly inhibits the growth of Listeria on a pasta filata cheese such as mozzarella, while the growth of Listeria on a pasta filata cheese such as mozzarella is not inhibited by endolysins having optimum lytic activity at a pH of above 6.

### Example 3

### pH Profiling and Log Reduction of Endolysin GU3-825

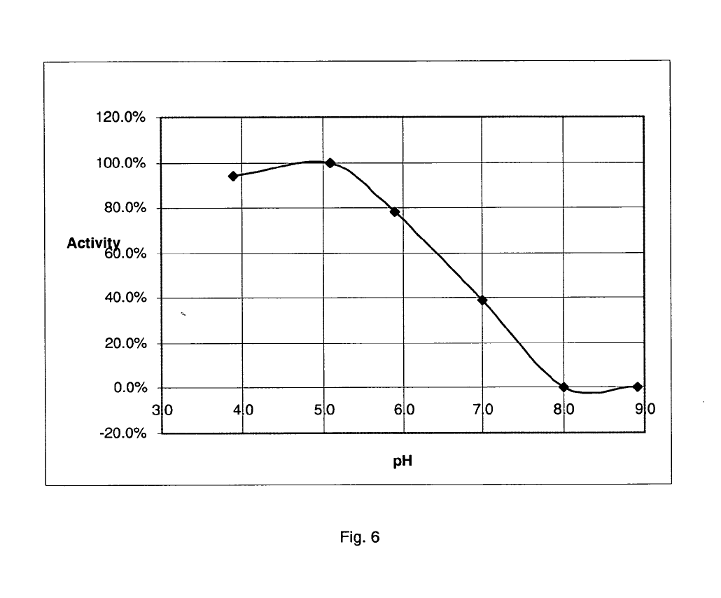

Endolysin gu3-825 has a pH optimum below pH 6 with respect to its lytic activity, as shown in FIG. 6. Endolysin activity is analyzed by the incubation of killed off Listeria monocytogenes cell suspensions and measuring the decrease in OD₆₀₀ at 30° C. The maximum slope during lysis of the cells can be related to the maximum slope corresponding with a known concentration of purified endolysin.

The minimum bactericidal concentrations (MBCs) of endolysins gu3-825 and PlyP40 in milk were determined and compared. As a result, the use of endolysin gu3-825 shows a log reduction of 5.1 throughout all protein concentrations tested (data not shown). The log reduction of endolysin PlyP40 varies between 2.6 and 5.3 over the protein concentrations tested (data not shown).

### Example 4

### Treatment of Mozzarella Cheese with Endolysin PlyP40 and GU3-825

The inhibiting effect on growth of Listeria monocytogenes on mozzarella cheese is shown after treatment with endolysin PlyP40 (SEQ ID NO: 2) and GU3-825 (SEQ ID NO: 6).

Slices of Mozzarella cheese of 2 cm×5 cm×1 cm were prepared. 100 μl of an aqueous preparation of endolysin PlyP40 (100 μg/ml in 50 mM phosphate buffer [50 mM NaH2PO4 with 50 mM Na2HPO4 to pH 5.5]) was applied on the surface of the mozzarella slices. Also, 100 μl of an aqueous preparation of endolysin GU3-825 (400 μg/ml in 50 mM phosphate buffer with 50 mM NaCl) was applied on the surface of the mozzarella slices. As a control, 100 μl water was applied on the surface of mozzarella slices. Next, 10 μl of Listeria monocytogenes inoculum comprising 1.5×10⁵ cfu was applied on the slices. The applied liquids were spread evenly over the surface of the mozzarella cheese slices and the slices were incubated for 0, 24 or 48 hours at 15° C. After incubation, each of the slices was washed in 20 ml of an aqueous solution comprising 0.1% w/w peptone. Next, serial dilutions of the obtained washing solutions were made (dilution factor: 20 times, 100 times, 1000 times, 10,000 times, 100,000 times) and 1 ml of the diluted washing solutions was applied onto selective Modified Oxford Medium (MOX) agar plates with Antimicrobic Supplement using the pour plate method. The plates were incubated for 48 hours at 35° C.

Colonies of Listeria on MOX typically appear as black indentations and often turn the surrounding agar black due to esculin-hydrolyzation. Colonies exhibiting these characteristic colony morphologies and biochemical reactions were counted.

Calculations on the lysis of Listeria were based on dilutions leading to around 100 colonies per plate and when only lower numbers were present on plates with the lowest diluted sample (i.e., 20 times dilution factor), these numbers were used.

The results are shown in FIG. 7. The results clearly show that endolysins PlyP40 and GU3-825, both having a pH optimum of pH 6 or below, can be used to control Listeria contamination of a pasta filata cheese.

SEQUENCE LISTING

SEQ ID NO: 1: Nucleotide sequence of endolysin
PlyP40 (1032 nucleotides; origin: bacteriophage
P40)
ATGGTATTAG TTTTAGACAT TTCAAAATGG CAACCGACAG
TGAATTATTC AGGACTAAAA GAAGATGTAG GATTCGTTGT
CATTCGTTCT AGCAACGGAA CACAGAAGTA TGATGAGAGA
TTAGAGCAAC ACGCAAAAGG CTTAGATAAA GTGGGAATGC
CTTTCGGACT GTACCACTAC GCTTTATTTG AAGGTGGACA
AGATACTATC AATGAAGCGA ATATGTTAGT TAGCGCATAT
AAGAAATGTC GTCAATTAGG CGCAGAACCA ACATTCTTGT
TCTTAGATTA TGAAGAAGTC AAGTTAAAAT CTGGTAATGT
GGTAAACGAA TGTCAGAGAT TTATAGACCA TGTGAAAGGT
CAAACTGGGG TCAAAGTAGG ACTTTATGCT GGGGATAGTT
TTTGGAAGAC GCACGATTTA GATAAAGTCA AGCACGATTT
AAGATGGGTA GCTAGATATG GGGTAGATAA CGGTAAACCG
TCTACAAAAC CATCTATACC TTATGATTTG TGGCAGTATA
CTTCCAAGGG GCGAATTAAA GCCATTGCTT CACCTGTAGA
TATGAATACA TGTTCTAGCG ACATATTGAA CAAATTAAAA
GGTTCAAAAG CACCTGTTAA ACCAGCACCA AAACCGACAC
CTAGTAAGCC AGCACCAGCG AAACCAGCAC CAAAAACGAC
TACTAAATAT GTCAATACGG CACATTTAAA TATTCGTGAA
AAGGCAAGTG CTGACTCGAA AGTATTGGGA GTTCTTGACC
TCAACGATTC CGTACAGGTC ATTTCTGAAT CAGGTGGATG
GTCTAAGTTG AAATCTGGGA ACAAGCAAGT ATATGTTTCT
TAGCAAGTATC TAGTAAGTC AAAAACGACA CCGAAGGCGA
AACCAAGCTC GAAACAGTAT TATACTATTA AAAGCGGTGA
TAATTTAAGT TACATTGCTA AGAAGTATAA AACTACAGTA
AAACAGATTC AAAACTGGAA CGGTATCAAG GATGCTAACA
AAATTTACGC AGGTCAAAAA ATTAGAGTTA AA
SEQ ID NO: 2: Amino acid sequence of
endolysin PlyP40 (344 amino acid residues;
origin: bacteriophage P40)
MVLVLDISKW QPTVNYSGLK EDVGFVVIRS SNGTQKYDER
LEQHAKGLDK VGMPFGLYHY ALFEGGQDTI NEANMLVSAY
KKCRQLGAEP TFLFLDYEEV KLKSGNVVNE CQRFIDHVKG
QTGVKVGLYA GDSFWKTHDL DKVKHDLRWV ARYGVDNGKP
STKPSIPYDL WQYTSKGRIK AIASPVDMNT CSSDILNKLK
GSKAPVKPAP KPTPSKPAPA KPAPKTTTKY VNTAHLNIRE
KASADSKVLG VLDLNDSVQV ISESGGWSKL KSGNKQVYVS
SKYLSKSKTT PKAKPSSKQY YTIKSGDNLS YIAKKYKTTV
KQIQNWNGIK DANKIYAGQK IRVK
SEQ ID NO: 3 Nucleotide sequence of endolysin
PlyP825 (945 nucleotides; origin:
bacteriophage P825)
atggcattaa cagaagcatg gcttcttgaa aaagccaata
gacgtttaaa cgaaaaaggg atgcttaaag aagtttcaga
taaaacccgt gcagtaatta aagagatggc taaacaaggt
atttacatca atgttgcaca aggcttccgt tctattgcag
aacagaatga attatatgca caaggcagaa caaagcccgg
caatgtggta acaaatgcaa agggaggtca atcaaatcat
aactacggtg ttgctgtaga cttatgccaa tacacgcaag
atggtaaaga tgtaatctgg gcggtagatg ctaagtttaa
aaagattgta gctgccatga agaaacaagg attcaaatgg
ggtggagatt ggaaatcttt taaagacaac cctcattttg
agttatatga ttgggtagga ggagaacgtc ctaactccag
cactcccgct aaaccatcca aaccatctac acctgcgaag
ccttctggtg aacttggtct cgtagattac atgaacagca
agaaaatgga ttcctctttt gctaatcgta aagtacttgc
tggaaaatat ggcatcaaga attatacagg aaccacttca
cagaatacac aactattagc taagattaaa gcaggtgcac
caaaacacgc tactccaaaa cctccggcta aaccagctac
ttctgggatg tacgtatact tccctgctgg taaaggtact
tggagtgtgt atccattaaa taaagcacct gtaaaagcta
atgcaatcgg agcaattaac ccttcgaagt ttggtggact
gacttacaaa gtcgaaaaga attacggaga taatgttcta
ggaattaaga ctggttcctt tggacatgtc aaagtatatt
gccacccatc aactggtgta aaaattagca acaacggagc
aggaaatttt ccgaatgttc agaat
SEQ ID NO: 4 Amino acid sequence of endolysin
PlyP825 (315 amino acid residues; origin:
bacteriophage P825)
MALTEAWLLE KANRRLNEKG MLKEVSDKTR AVIKEMAKQC
IYINVAQGFR SIAEQNELYA QGRTKPGNVV TNAKGGQSNH
NYGVAVDLCQ YTQDGKDVIW AVDAKFKKIV AAMKKQGFKW
GGDWKSFKDN PHFELYDWVG GERPNSSTPA KPSKPSTPAK
PSGELGLVDY MNSKKMDSSF ANRKVLAGKY GIKNYTGTTS
QNTQLLAKIK AGAPKHATPK PPAKPATSGM YVYFPAGKGT
WSVYPLNKAP VKANAIGAIN PSKFGGLTYK VEKNYGDNVL
GIKTGSFGHV KVYCHPSTGV KISNNGAGNF PNVQN
SEQ ID NO: 5 Nucleotide sequence of endolysin
gu3-825 (1,641 nucleotides; origin: artificial)
atggcat tagtcctcga catcagcaag tggcaaccga
cggtaaacta tagcggtctg aaagaggatg tgggttttgt
ggtcatccgt agctccaatg gtacgcagaa atatgacgaa
cgcctggaac agcacgcgaa aggtctggac aaagttggta
tgccgtttgg tctgtaccat tacgcgctgt ttgagggtgg
tcaagacacc attaatgaag caaacatgtt ggttagcgcg
tacaagaaat gccgtcagct gggtgccgag ccgactttcc
tgttcctgga ttacgaagaa gtgaagctga agtccggcaa
cgtcgtgaat gagtgtcagc gcttcattga ccacgttaaa
ggtcaaacgg gtgtcaaagt tggcttgtat gcgggcgata
gcttctggaa aacccacgac ctggataagg tcaagcatga
cttgcgctgg gtcgcgcgtt acggcgtgga taacggtaag
ccgagcacca aaccgagcat cccgtacgac ctgtggcagt
atacttccaa aggccgtatt aaggccattg ctagcccggt
cgatatgaac acctgcagca gcgacatcct gaacaagctg
aaaggtagca aagcgccggt gaaacctgcg ccgaagccga
ccccgagcaa gccagcacca gcgaaaccgg ctcctaaagg
cagcctgcaa atggcgagca ccccgtctac caacctggac
aagctgggcc tggtggatta catgaatgcg aagaaaatgg
acagctcgta cagcaatcgc gataagctgg caaaacagta
cggtatcgcg aactattccg gcaccgctag ccagaatacc
accctgctga gcaagatcaa gggtggtgct ccgaagccga
gcaccccggc accgaaaccg tctacgagca ccgcgaaaaa
gatttacttt ccgccgaata aaggtaactg gagcgtttat
ccgacgaaca aagcgccggt caaagcgaat gcaattggtg
caattaaccc gaccaagttc ggtggcctga cctataccat
tcaaaaagac cgtggcaatg gtgtttatga aatccagacc
gaccaattcg gtcgcgttca agtctatggt gcgccgtcca
cgggtgccgt gatcaagaaa accagcggcg gtagcaagcc
aggcggtacg aaaccgggtg gctccaagcc gggtagcgtc
gatatggcgt taacagaagc atggcttctt gaaaaagcca
atagacgttt aaacgaaaaa gggatgctta aagaagtttc
agataaaacc cgtgcagtaa ttaaagagat ggctaaacaa
ggtatttaca tcaatgttgc acaaggcttc cgttctattg
cagaacagaa tgaattatat gcacaaggca gaacaaagcc
cggcaatgtg gtaacaaatg caaagggagg tcaatcaaat
cataactacg gtgttgctgt agacttatgc caatacacgc
aagatggtaa agatgtaatc tgggcggtag atgctaagtt
taaaaagatt gtagctgcca tgaagaaaca aggattcaaa
tggggtggag attggaaatc ttttaaagac aaccctcatt
ttgagttata tgattgggta ggaggagaac gtcctaactc
cagc
SEQ ID NO: 6 Amino acid sequence of endolysin
gu3-825 (547 amino acid residues; origin:
artificial)
malvldiskw qptvnysglk edvgfvvirs sngtqkyder
leqhakgldk vgmpfglyhy alfeggqdti neanmlvsay
kkcrqlgaep tflfldyeev klksgnvvne cqrfidhvkg
qtgvkvglya gdsfwkthdl dkvkhdlrwv arygvdngkp
stkpsipydl wqytskgrik aiaspvdmnt cssdilnklk
gskapvkpap kptpskpapa kpapkgslqm astpstnldk
lglvdymnak kmdssysnrd klakqygian ysgtasqntt
llskikggap kpstpapkps tstakkiyfp pnkgnwsvyp
tnkapvkana igainptkfg gltytiqkdr gngvyeiqtd
qfgrvqvyga pstgavikkt sggskpggtk pggskpgsvd
malteawlle kanrrlnekg mlkevsdktr avikemakqg
iyinvaqgfr siaeqnelya qgrtkpgnvv tnakggqsnh
nygvavdlcq ytqdgkdviw avdakfkkiv aamkkqgfkw
ggdwksfkdn phfelydwvg gerpnss

1. A method for controlling Listeria contamination of pasta filata cheese or a pasta filata cheese food product comprising applying a Listeria bacteriophage endolysin to pasta filata cheese or a pasta filata cheese food product, wherein said endolysin comprises a pH-optimum of not more than 6.0 with regard to lytic activity thereof.

2. The method of claim 1, wherein said pasta filata cheese is mozzarella cheese, and wherein said pasta filata cheese food product is a mozzarella cheese food product.

3. The method of claim 1, further comprising applying to said pasta filata cheese or said pasta filata cheese food product at least one Listeria-specific bacteriophage.

4. The method of claim 1, wherein said endolysin is encoded by a nucleic acid molecule comprising a polynucleotide selected from the group consisting of:
(a) a polynucleotide encoding a polypeptide having the amino acid sequence of SEQ ID NO: 2;
(b) a polynucleotide encoding a fragment, analog and/or functional derivative of a polypeptide encoded by the polynucleotide of (a), wherein said fragment, analog and/or functional derivative has endolysin activity;
(c) a polynucleotide comprising the nucleotide sequence of SEQ ID NO: 1;
(d) a polynucleotide comprising part of the nucleotide sequence of (c) and
which encodes a fragment, analog and/or functional derivative of a polypeptide having the amino acid sequence of SEQ ID NO: 2, wherein said fragment, analog and/or functional derivative comprises endolysin activity; and
(e) a polynucleotide that is the complement of the full length of a polynucleotide of any of (a) to (d).

5. A food product comprising a pasta filata cheese and a Listeria bacteriophage endolysin.

6. The food product of claim 5, wherein said endolysin comprises a pH-optimum of not more than 6.0 with regard to lytic activity thereof.

7. The food product of claim 5, wherein said pasta filata cheese is mozzarella cheese.

8. The food product of claim 5, further comprising at least one Listeria-specific bacteriophage.

9. The food product of claim 5, wherein said endolysin is encoded by a nucleic acid molecule comprising a polynucleotide selected from the group consisting of:
(a) a polynucleotide encoding a polypeptide having the amino acid sequence of SEQ ID NO: 2;
(b) a polynucleotide encoding a fragment, analog and/or functional derivative of a polypeptide encoded by the polynucleotide of (a), wherein said fragment, analog or functional derivative comprises endolysin activity;
(c) a polynucleotide comprising the nucleotide sequence of SEQ ID NO: 1;
(d) a polynucleotide comprising part of the nucleotide sequence of (c) and which encodes a fragment, analog and/or functional derivative of a polypeptide having the amino acid sequence of SEQ ID NO: 2, wherein said fragment, analog and/or functional derivative comprises endolysin activity; and
(e) a polynucleotide that is the complement of the full length of a polynucleotide of any of (a) to (d).

10. A method of making the food product of claim 5, comprising adding a Listeria bacteriophage endolysin to a pasta filata cheese.

11. The method of claim 10, wherein said endolysin comprises a pH-optimum of not more than 6.0 with regard to lytic activity thereof.

12. The method of claim 10, wherein said pasta filata cheese is a mozzarella cheese.

13. The method of claim 10, further comprising adding at least one Listeria-specific bacteriophage to said pasta filata cheese.

14. The method of claim 10, wherein said endolysin is encoded by a nucleic acid molecule comprising a polynucleotide selected from the group consisting of:
(a) a polynucleotide encoding a polypeptide having the amino acid sequence of SEQ ID NO: 2
(b) a polynucleotide encoding a fragment, analog and/or functional derivative of a polypeptide encoded by the polynucleotide of (a), wherein said fragment, analog and/or functional derivative comprising endolysin activity;
(c) a polynucleotide comprising the nucleotide sequence of SEQ ID NO: 1;
(d) a polynucleotide comprising part of the nucleotide sequence of (c) and which encodes a fragment, analog and/or functional derivative of a polypeptide having the amino acid sequence of SEQ ID NO: 2, wherein said fragment, analog and/or functional derivative comprising endolysin activity; and
(e) a polynucleotide that is the complement of the full length of a polynucleotide of any of (a) to (d).


SEQUENCE LISTING (6 sequences)

SEQ ID NO: 1 - DNA, 1032 bp, bacteriophage P40
  misc_feature (1)..(1032): nucleotide sequence of endolysin PlyP40
atggtattagttttagacatttcaaaatggcaaccgacagtgaattattcaggactaaaagaagatgtaggattcgttgtcattcgttctagcaacggaacacagaagtatgatgagagattagagcaacacgcaaaaggcttagataaagtgggaatgcctttcggactgtaccactacgctttatttgaaggtggacaagatactatcaatgaagcgaatatgttagttagcgcatataagaaatgtcgtcaattaggcgcagaaccaacattcttgttcttagattatgaagaagtcaagttaaaatctggtaatgtggtaaacgaatgtcagagatttatagaccatgtgaaaggtcaaactggggtcaaagtaggactttatgctggggatagtttttggaagacgcacgatttagataaagtcaagcacgatttaagatgggtagctagatatggggtagataacggtaaaccgtctacaaaaccatctataccttatgatttgtggcagtatacttccaaggggcgaattaaagccattgcttcacctgtagatatgaatacatgttctagcgacatattgaacaaattaaaaggttcaaaagcacctgttaaaccagcaccaaaaccgacacctagtaagccagcaccagcgaaaccagcaccaaaaacgactactaaatatgtcaatacggcacatttaaatattcgtgaaaaggcaagtgctgactcgaaagtattgggagttcttgacctcaacgattccgtacaggtcatttctgaatcaggtggatggtctaagttgaaatctgggaacaagcaagtatatgtttctagcaagtatcttagtaagtcaaaaacgacaccgaaggcgaaaccaagctcgaaacagtattatactattaaaagcggtgataatttaagttacattgctaagaagtataaaactacagtaaaacagattcaaaactggaacggtatcaaggatgctaacaaaatttacgcaggtcaaaaaattagagttaaa

SEQ ID NO: 2 - protein, 344 aa, bacteriophage P40
  MISC_FEATURE (1)..(344): amino acid sequence of endolysin PlyP40
MVLVLDISKWQPTVNYSGLKEDVGFVVIRSSNGTQKYDERLEQHAKGLDKVGMPFGLYHYALFEGGQDTINEANMLVSAYKKCRQLGAEPTFLFLDYEEVKLKSGNVVNECQRFIDHVKGQTGVKVGLYAGDSFWKTHDLDKVKHDLRWVARYGVDNGKPSTKPSIPYDLWQYTSKGRIKAIASPVDMNTCSSDILNKLKGSKAPVKPAPKPTPSKPAPAKPAPKTTTKYVNTAHLNIREKASADSKVLGVLDLNDSVQVISESGGWSKLKSGNKQVYVSSKYLSKSKTTPKAKPSSKQYYTIKSGDNLSYIAKKYKTTVKQIQNWNGIKDANKIYAGQKIRVK

SEQ ID NO: 3 - DNA, 945 bp, bacteriophage P825
  misc_feature (1)..(945): nucleotide sequence of endolysin PlyP825
atggcattaacagaagcatggcttcttgaaaaagccaatagacgtttaaacgaaaaagggatgcttaaagaagtttcagataaaacccgtgcagtaattaaagagatggctaaacaaggtatttacatcaatgttgcacaaggcttccgttctattgcagaacagaatgaattatatgcacaaggcagaacaaagcccggcaatgtggtaacaaatgcaaagggaggtcaatcaaatcataactacggtgttgctgtagacttatgccaatacacgcaagatggtaaagatgtaatctgggcggtagatgctaagtttaaaaagattgtagctgccatgaagaaacaaggattcaaatggggtggagattggaaatcttttaaagacaaccctcattttgagttatatgattgggtaggaggagaacgtcctaactccagcactcccgctaaaccatccaaaccatctacacctgcgaagccttctggtgaacttggtctcgtagattacatgaacagcaagaaaatggattcctcttttgctaatcgtaaagtacttgctggaaaatatggcatcaagaattatacaggaaccacttcacagaatacacaactattagctaagattaaagcaggtgcaccaaaacacgctactccaaaacctccggctaaaccagctacttctgggatgtacgtatacttccctgctggtaaaggtacttggagtgtgtatccattaaataaagcacctgtaaaagctaatgcaatcggagcaattaacccttcgaagtttggtggactgacttacaaagtcgaaaagaattacggagataatgttctaggaattaagactggttcctttggacatgtcaaagtatattgccacccatcaactggtgtaaaaattagcaacaacggagcaggaaattttccgaatgttcagaat

SEQ ID NO: 4 - protein, 315 aa, bacteriophage P825
  MISC_FEATURE (1)..(315): amino acid sequence of endolysin PlyP825
MALTEAWLLEKANRRLNEKGMLKEVSDKTRAVIKEMAKQGIYINVAQGFRSIAEQNELYAQGRTKPGNVVTNAKGGQSNHNYGVAVDLCQYTQDGKDVIWAVDAKFKKIVAAMKKQGFKWGGDWKSFKDNPHFELYDWVGGERPNSSTPAKPSKPSTPAKPSGELGLVDYMNSKKMDSSFANRKVLAGKYGIKNYTGTTSQNTQLLAKIKAGAPKHATPKPPAKPATSGMYVYFPAGKGTWSVYPLNKAPVKANAIGAINPSKFGGLTYKVEKNYGDNVLGIKTGSFGHVKVYCHPSTGVKISNNGAGNFPNVQN

SEQ ID NO: 5 - DNA, 1641 bp, Artificial Sequence
  nucleotide sequence of endolysin gu3-825
atggcattagtcctcgacatcagcaagtggcaaccgacggtaaactatagcggtctgaaagaggatgtgggttttgtggtcatccgtagctccaatggtacgcagaaatatgacgaacgcctggaacagcacgcgaaaggtctggacaaagttggtatgccgtttggtctgtaccattacgcgctgtttgagggtggtcaagacaccattaatgaagcaaacatgttggttagcgcgtacaagaaatgccgtcagctgggtgccgagccgactttcctgttcctggattacgaagaagtgaagctgaagtccggcaacgtcgtgaatgagtgtcagcgcttcattgaccacgttaaaggtcaaacgggtgtcaaagttggcttgtatgcgggcgatagcttctggaaaacccacgacctggataaggtcaagcatgacttgcgctgggtcgcgcgttacggcgtggataacggtaagccgagcaccaaaccgagcatcccgtacgacctgtggcagtatacttccaaaggccgtattaaggccattgctagcccggtcgatatgaacacctgcagcagcgacatcctgaacaagctgaaaggtagcaaagcgccggtgaaacctgcgccgaagccgaccccgagcaagccagcaccagcgaaaccggctcctaaaggcagcctgcaaatggcgagcaccccgtctaccaacctggacaagctgggcctggtggattacatgaatgcgaagaaaatggacagctcgtacagcaatcgcgataagctggcaaaacagtacggtatcgcgaactattccggcaccgctagccagaataccaccctgctgagcaagatcaagggtggtgctccgaagccgagcaccccggcaccgaaaccgtctacgagcaccgcgaaaaagatttactttccgccgaataaaggtaactggagcgtttatccgacgaacaaagcgccggtcaaagcgaatgcaattggtgcaattaacccgaccaagttcggtggcctgacctataccattcaaaaagaccgtggcaatggtgtttatgaaatccagaccgaccaattcggtcgcgttcaagtctatggtgcgccgtccacgggtgccgtgatcaagaaaaccagcggcggtagcaagccaggcggtacgaaaccgggtggctccaagccgggtagcgtcgatatggcgttaacagaagcatggcttcttgaaaaagccaatagacgtttaaacgaaaaagggatgcttaaagaagtttcagataaaacccgtgcagtaattaaagagatggctaaacaaggtatttacatcaatgttgcacaaggcttccgttctattgcagaacagaatgaattatatgcacaaggcagaacaaagcccggcaatgtggtaacaaatgcaaagggaggtcaatcaaatcataactacggtgttgctgtagacttatgccaatacacgcaagatggtaaagatgtaatctgggcggtagatgctaagtttaaaaagattgtagctgccatgaagaaacaaggattcaaatggggtggagattggaaatcttttaaagacaaccctcattttgagttatatgattgggtaggaggagaacgtcctaactccagc

SEQ ID NO: 6 - protein, 547 aa, Artificial Sequence
  amino acid sequence of endolysin gu3-825
MALVLDISKWQPTVNYSGLKEDVGFVVIRSSNGTQKYDERLEQHAKGLDKVGMPFGLYHYALFEGGQDTINEANMLVSAYKKCRQLGAEPTFLFLDYEEVKLKSGNVVNECQRFIDHVKGQTGVKVGLYAGDSFWKTHDLDKVKHDLRWVARYGVDNGKPSTKPSIPYDLWQYTSKGRIKAIASPVDMNTCSSDILNKLKGSKAPVKPAPKPTPSKPAPAKPAPKGSLQMASTPSTNLDKLGLVDYMNAKKMDSSYSNRDKLAKQYGIANYSGTASQNTTLLSKIKGGAPKPSTPAPKPSTSTAKKIYFPPNKGNWSVYPTNKAPVKANAIGAINPTKFGGLTYTIQKDRGNGVYEIQTDQFGRVQVYGAPSTGAVIKKTSGGSKPGGTKPGGSKPGSVDMALTEAWLLEKANRRLNEKGMLKEVSDKTRAVIKEMAKQGIYINVAQGFRSIAEQNELYAQGRTKPGNVVTNAKGGQSNHNYGVAVDLCQYTQDGKDVIWAVDAKFKKIVAAMKKQGFKWGGDWKSFKDNPHFELYDWVGGERPNSS